(19) United States
(12) Patent Application Publication
(10) Pub. No.: US 2011/0219135 A1
(43) Pub. Date: Sep. 8, 2011

(54) INFORMATION PROCESSING DEVICE, COMMUNICATION ADDRESS PROVIDING SYSTEM, METHOD AND PROGRAM USED FOR SAME

(76) Inventors: Takeaki Minamizawa, Tokyo (JP); Natsuko Kagawa, Tokyo (JP)

(21) Appl. No.: 13/128,749

(22) PCT Filed: Nov. 26, 2009
(86) PCT No.: PCT/JP2009/006377

§ 371 Date: May 11, 2011

(30) Foreign Application Priority Data
Nov. 26, 2008 (JP) 2008-301143 2008

(51) Int. Cl. G06F 15/16

(52) U.S. Cl. 709/230

(57) ABSTRACT

An information processing device includes: communication address providing means 103 for providing a communication address to a communication service providing server as a server for providing a communication service; HTTP protocol information receiving means 101 for receiving information indicative of communication status of a user terminal via an HTTP protocol; and communication address storage means 102 for storing the provided communication address in association with information capable of identifying a user or the user terminal specified by the communication address, wherein the communication address providing means 103 provides, based on the communication status, a communication address, capable of specifying the user terminal or the user using the user terminal that has performed communication, to the communication service providing server associated with a Web server as a communication partner via the HTTP protocol.

### TECHNICAL FIELD

The present invention relates to an information processing device, a communication address providing system, a communication address providing method, and a communication address providing program, which provide a communication address, such as an e-mail address or a telephone number, capable of specifying a user or a user terminal as a destination of a communication service, to a communication service providing server as a server for providing the communication service.

### BACKGROUND ART

There are communication services for advertising mail delivery or telephone solicitation by obtaining a communication address of a user, such as a mail address or a telephone number, on a questionnaire or prize site under the permission of the user.

However, once personal information such as the mail address or the telephone number is provided to a service provider, there is a problem that the user often gets unsolicited mails or unwanted calls using the provided mail address or telephone number in the event of leak accident of the personal information from the service provider or when the service provider itself is malicious.

To prevent such a problem, a system for creating a temporary communication address is proposed. For example, Patent Literature 1 discloses a communication system for creating a new temporary mail address in association with an existing mail address of a user in response to a request from a user terminal.

Further, for example, Patent Literature 2 discloses an address conversion system for making e-mail available using a temporary e-mail address only for a required period of time with a simple operation.

Further, as a document describing a matter related to a technique for using information capable of being obtained on an HTTP proxy server to identify a user, there is Patent Literature 3. In addition, as a document describing a matter related to a technique for using taste information to enable transmission of advertisements from a marketing server, there is Patent Literature 4.

### CITATION LIST

### Patent Literature

PTL 1: Japanese Patent Application Publication No. 2003-141042

PTL 2: Japanese Patent Application Publication No. 2005-72707

PTL 3: Japanese Patent Application Publication No. 2002-073431

PTL 4: Japanese Patent Application Publication No. 2003-281177

### SUMMARY OF INVENTION

### Technical Problem

However, in the communication system disclosed in Patent Literature 1 and the address conversion system disclosed in Patent Literature 2, when the site operator side of a website wants to send a mail to a user voluntarily, it needs to get a currently valid temporary communication address assigned to the user by a method of having the user enter the mail address in an input area on the website or send a blank mail without text to a mail address listed on the website. In other words, there is a problem that the service provider side cannot provide a communication service, such as an advertising mail or an advertising phone call, actively to a user who shows interest in the website without such an operation.

Further, the method disclosed in Patent Literature 3 is a method of measuring performance in a WWW service for communication via an HTTP protocol between an HTTP client of a user terminal using an HTTP proxy server and a WWW server, and no regard is given to use of these pieces of information to control transmission authority given to the service provider for communication service. In other words, no regard is given to use of information available on the HTTP proxy server to allow the service provider side to provide a communication service, such as delivery of an advertising mail or an advertising phone call, actively to a user who shows interest in the website.

Further, in the method disclosed in Patent Literature 4, when a URL of an advertising mail is specified by the user, identification information capable of identifying the user anonymously in an advertisement providing device is created, and the created identification information is encrypted and embedded in the URL to identify an URL of an advertiser and the user from the URL. Then, based on the public range of the user identified, redirection is done to the URL of the advertiser as a request in which personal information is embedded. Thus, according to the method, the user is anonymous on the communication path, but the personal information is provided to the advertiser though within a limited public range. This may cause the delivery of unsolicited mails or unwanted calls using the personal information due to carelessness of the advertiser or the like.

Therefore, it is an object of the present invention to provide an information processing device, a communication address providing system, a communication address providing method, and a communication address providing program, which provide a communication address to allow a service provider to specify a user or a user terminal used by the user so that the user can receive a communication service related to a website in which the user shows interest securely without special operations.

### Solution to Problem

An information processing device according to the present invention is characterized by comprising: communication address providing means for providing a communication address, capable of specifying a user or a user terminal as a destination of a communication service, to a communication service providing server as a server for providing the communication service; HTTP protocol information receiving means for receiving information indicative of communication status of the user terminal via an HTTP protocol; and communication address storage means for storing the communication address, provided by the communication address providing means, in association with information capable of identifying the user or the user terminal specified by the communication address, wherein, based on the communication status of the user terminal via the HTTP protocol, the communication address providing means provides a communication address capable of specifying the user terminal or the user using the user terminal to the communication service providing server associated with a Web server as a communication partner via the HTTP protocol.

An anonymous communication address providing system according to the present invention is characterized by comprising: communication address providing means for providing a communication address, capable of specifying a user or a user terminal as a destination of a communication service, to a communication service providing server as a server for providing the communication service; HTTP protocol information receiving means for receiving information indicative of communication status of the user terminal via an HTTP protocol; and communication address storage means for storing the communication address, provided by the communication address providing means, in association with information capable of identifying the user or the user terminal specified by the communication address, wherein, based on the communication status of the user terminal via the HTTP protocol, the communication address providing means provides a communication address, capable of specifying the user terminal or the user using the user terminal, to the communication service providing server associated with a Web server as a communication partner via the HTTP protocol.

An anonymous communication address providing method according to the present invention is to provide a communication address, capable of specifying a user or a user terminal as a destination of a communication service, to a communication service providing server as a server for providing the communication service, the method characterized by comprising: obtaining information indicative of communication status of the user terminal or a user terminal used by the user via an HTTP protocol, wherein the communication address is to be assigned to the user terminal; providing, based on the obtained communication status of the user terminal via the HTTP protocol, a communication address, capable of specifying the user terminal or the user using the user terminal, to the communication service providing server associated with a Web server as a communication partner via the HTTP protocol; and storing, in a storage device, the provided communication address in association with information capable of identifying the user or the user terminal specified by the communication address.

An anonymous communication address providing program according to the present invention is to provide a communication address, capable of specifying a user or a user terminal as a destination of a communication service, to a communication service providing server as a server for providing the communication service, the program characterized by making a computer perform processing for receiving information indicative of communication status of the user terminal or a user terminal used by the user via an HTTP protocol, wherein the communication address is to be assigned to the user terminal, and processing for providing, based on the obtained communication status of the user terminal via the HTTP protocol, a communication address capable of specifying the user terminal or the user using the user terminal to the communication service providing server associated with a Web server as a communication partner via the HTTP protocol.

### Advantageous Effects of Invention

According to the present invention, a user can receive a communication service related to a website in which the user shows interest securely without special operations. A service provider can use advertising mails or calls to conduct promotional activities actively for the user showing interest.

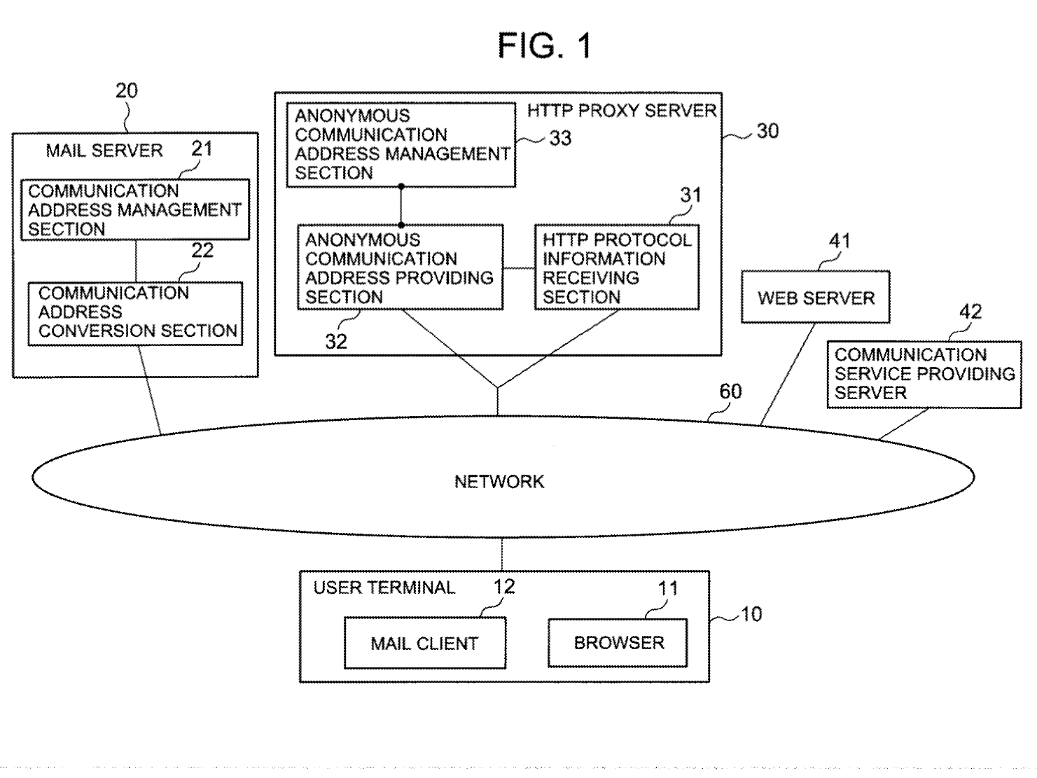

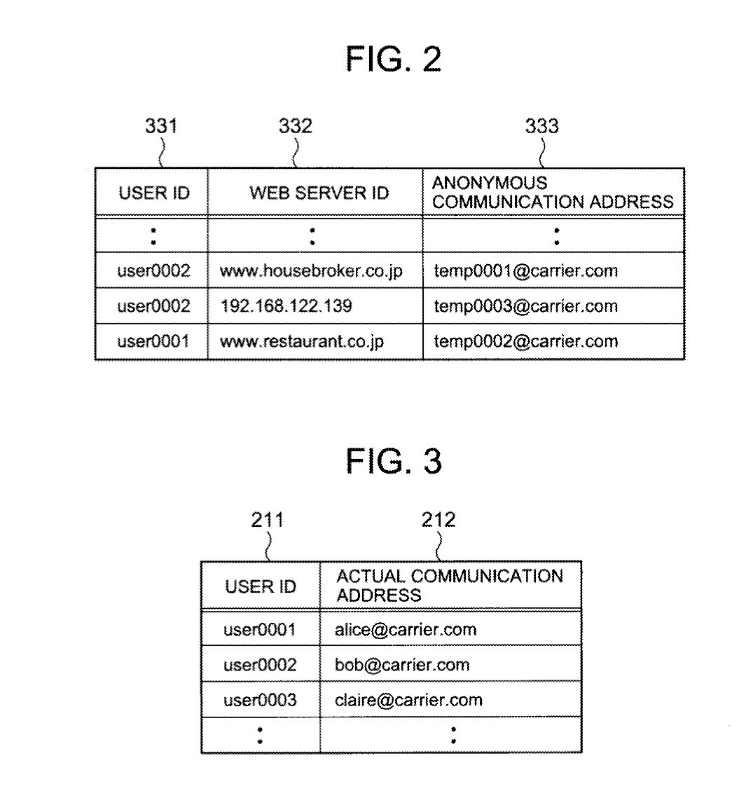

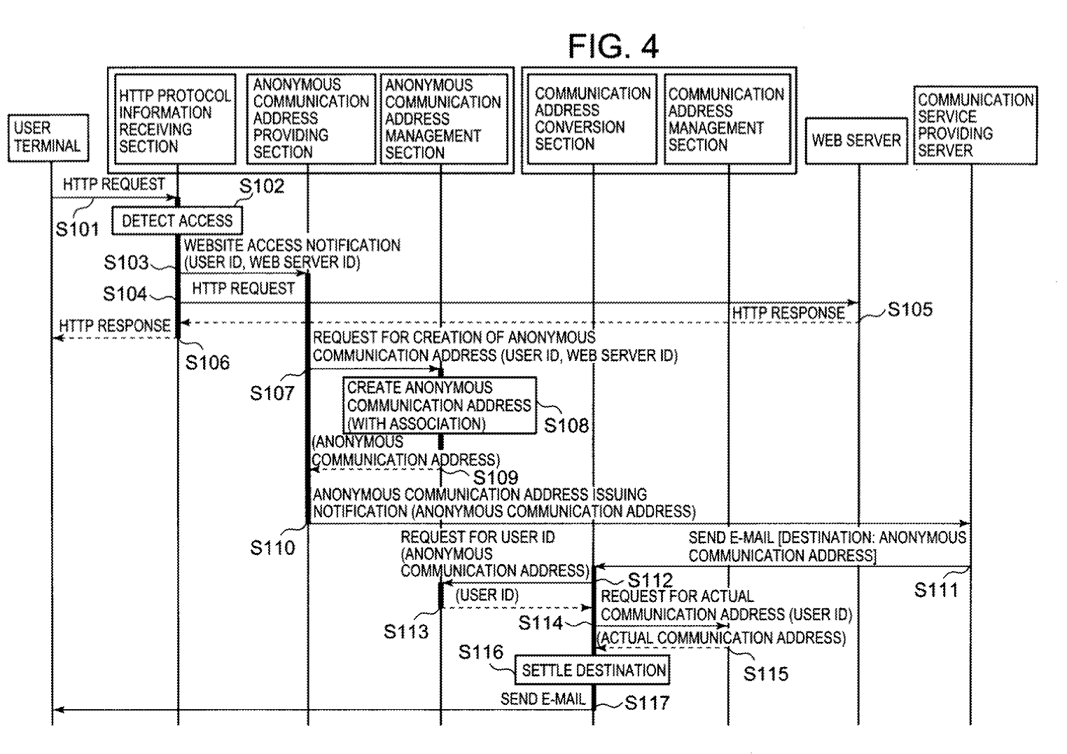

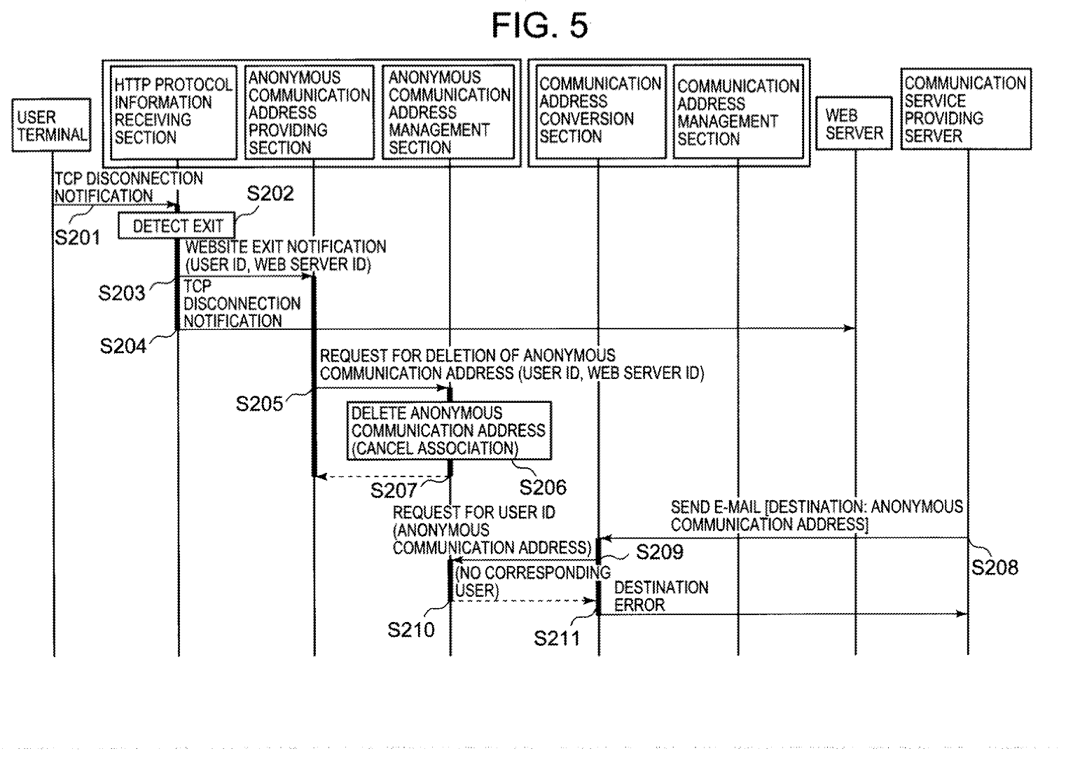

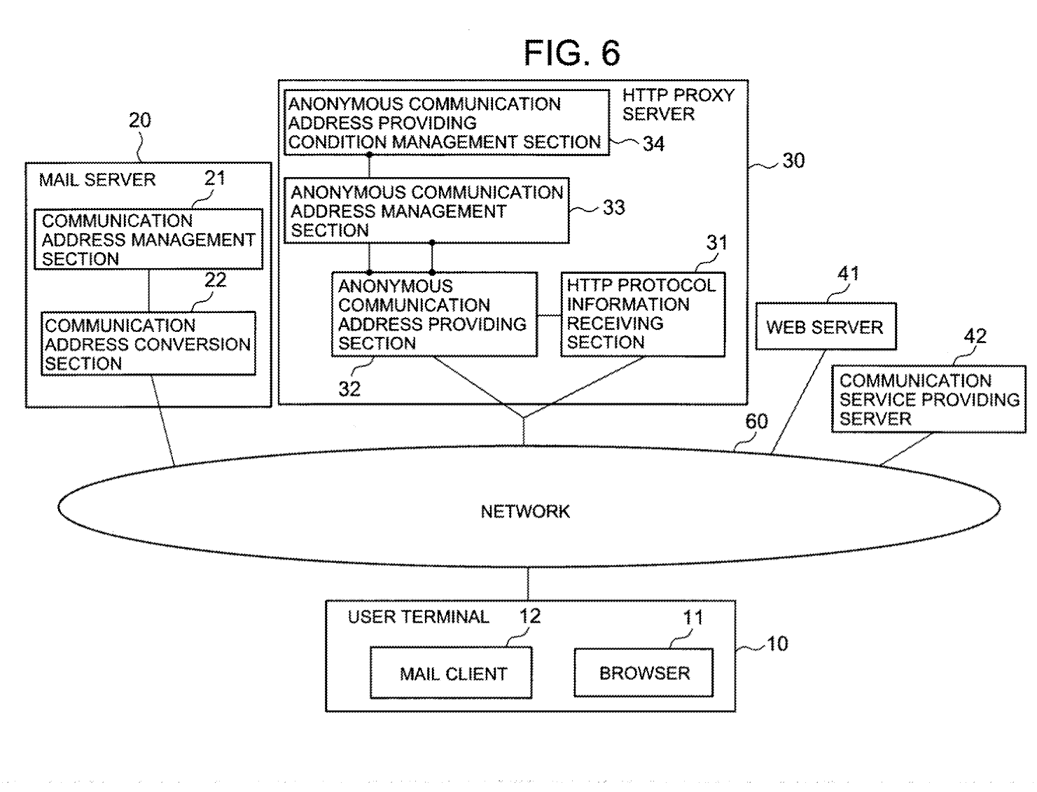

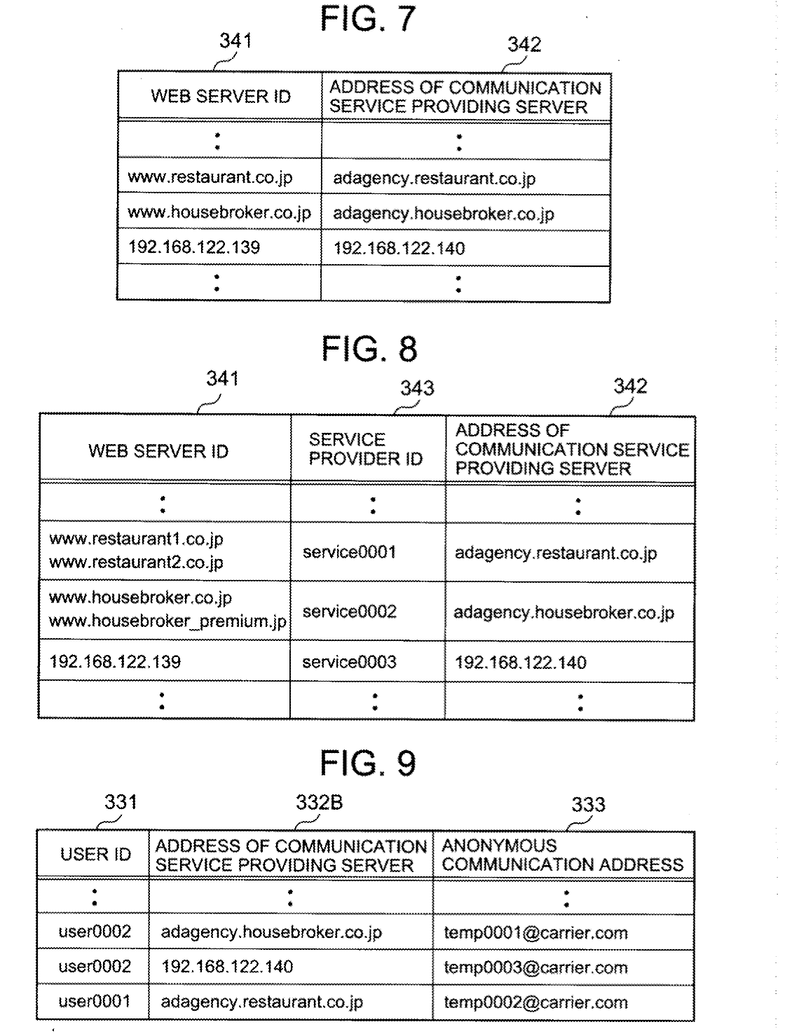

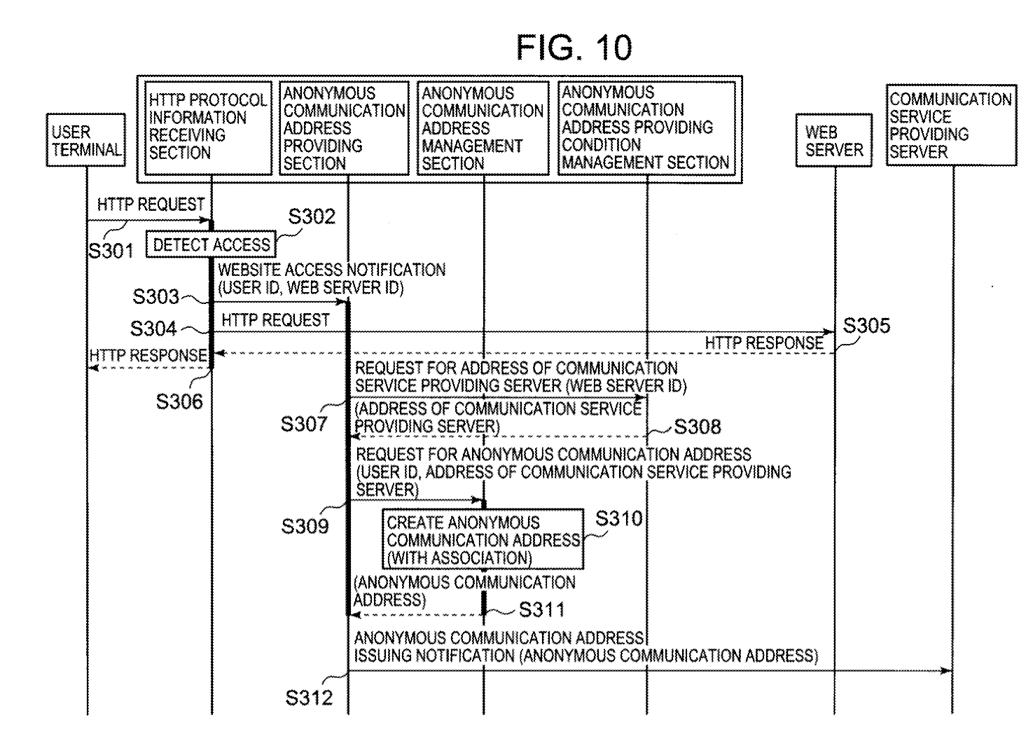

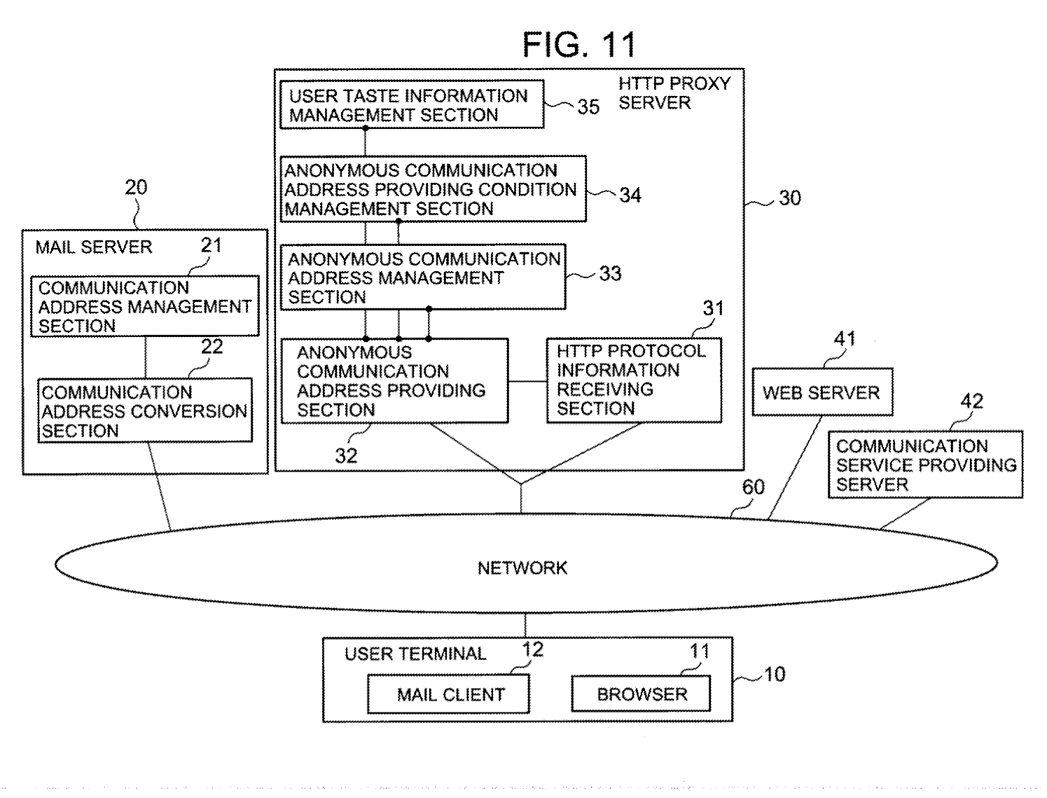

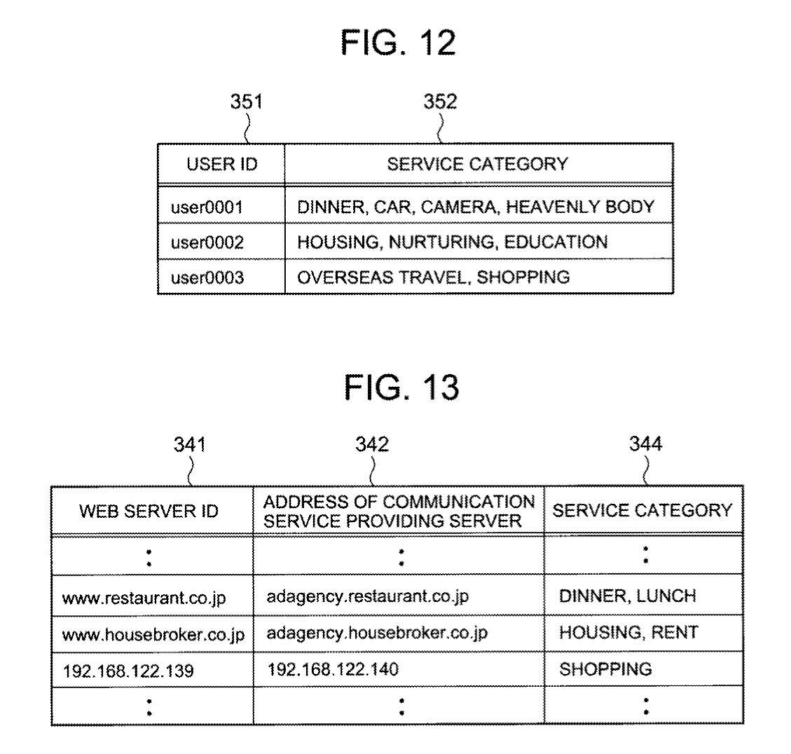

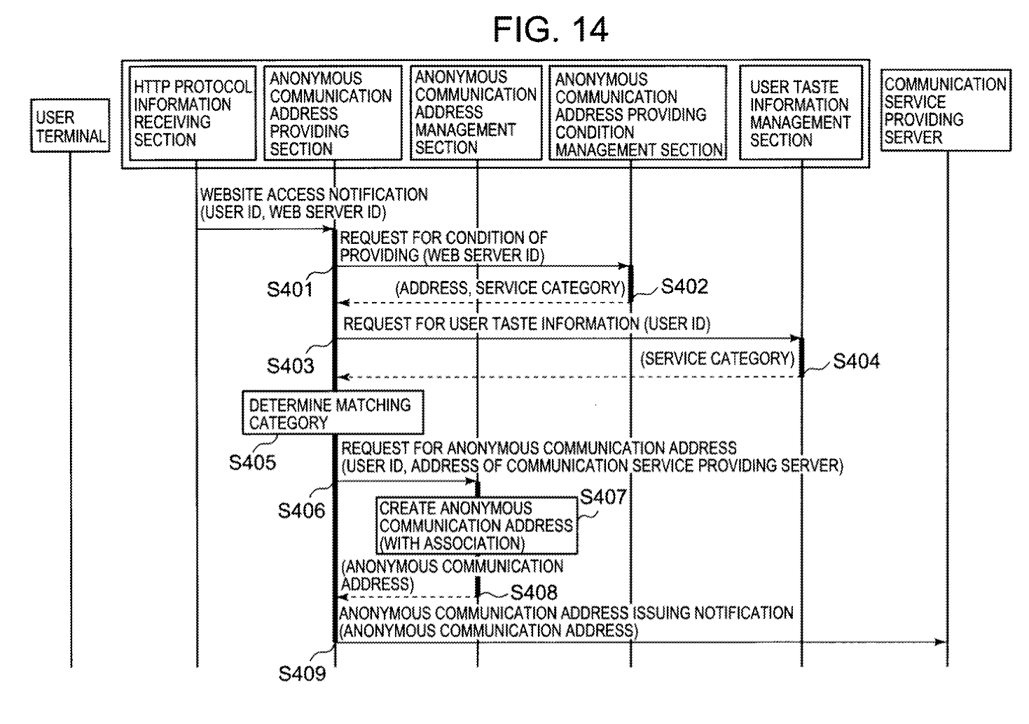

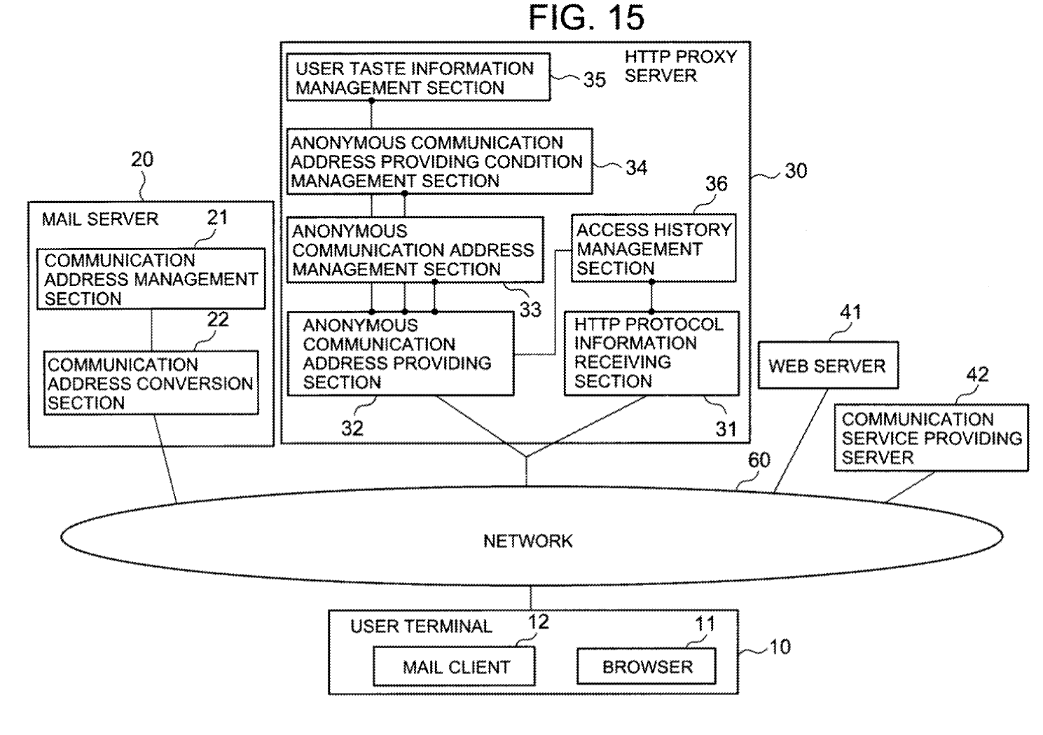

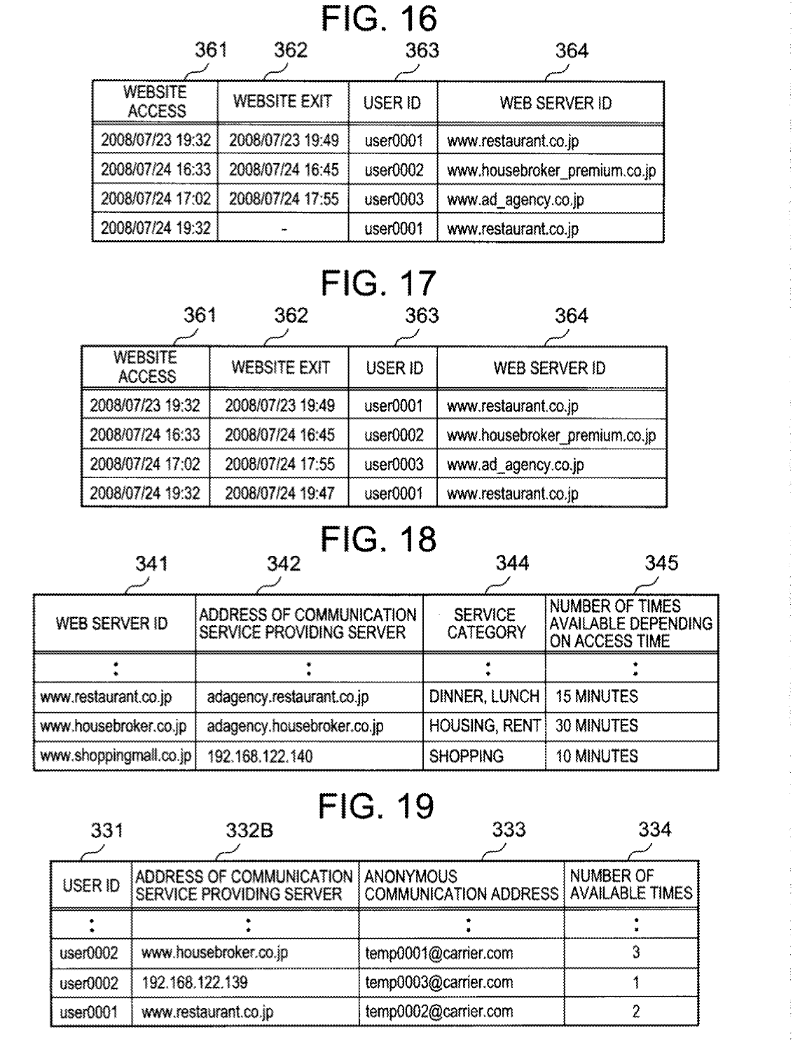

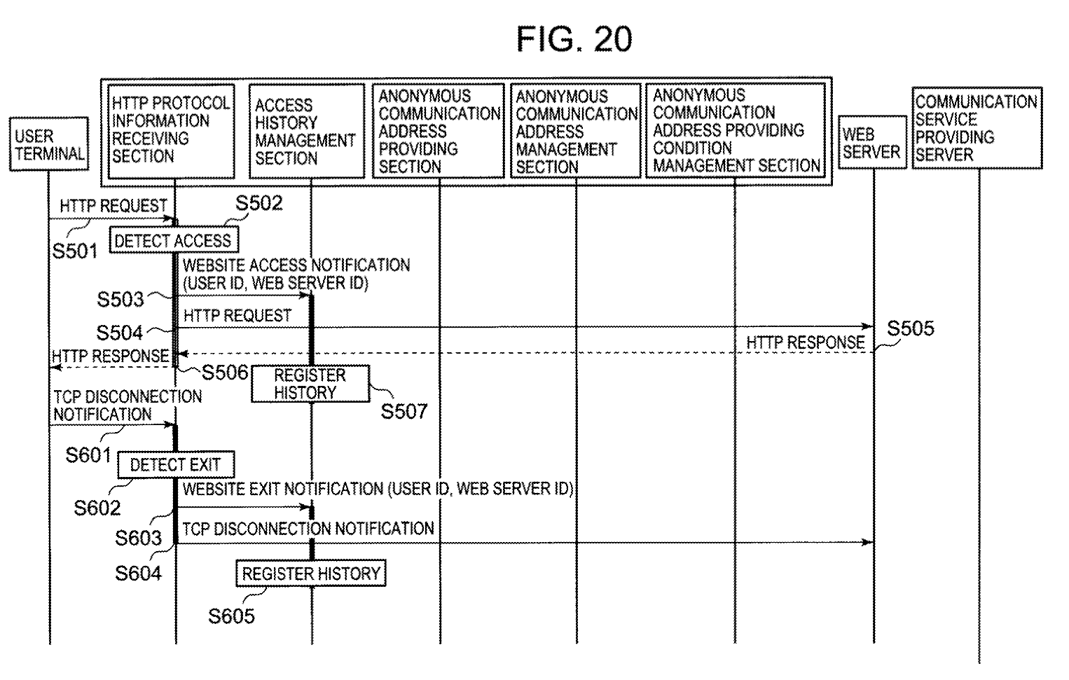

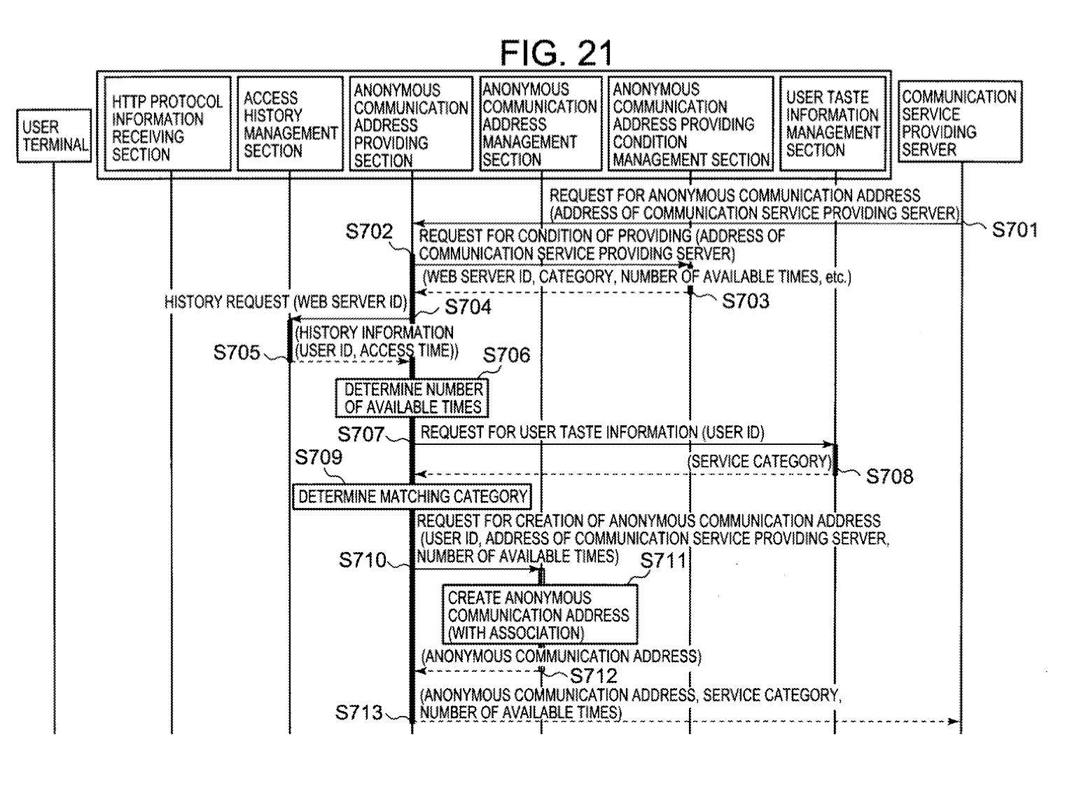

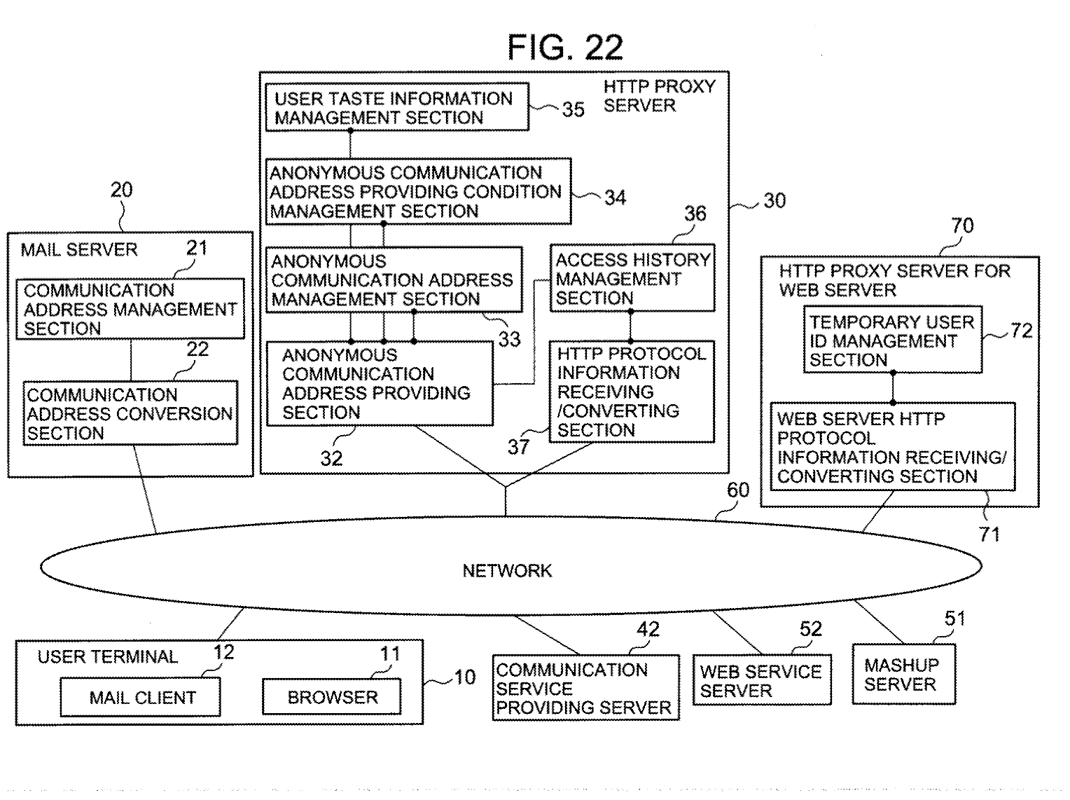

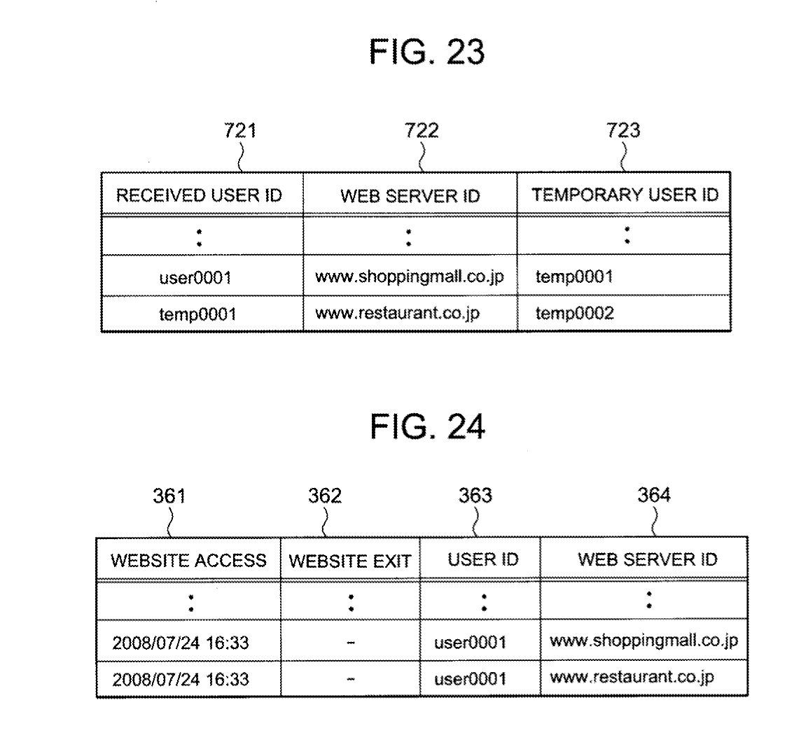

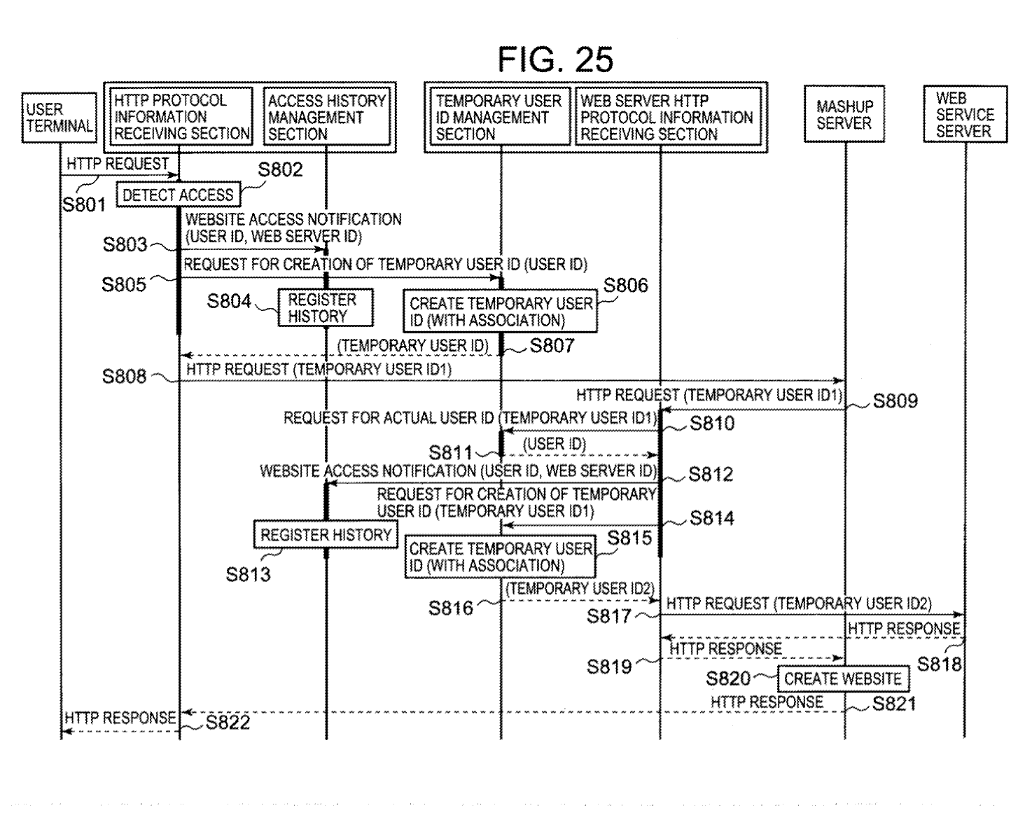

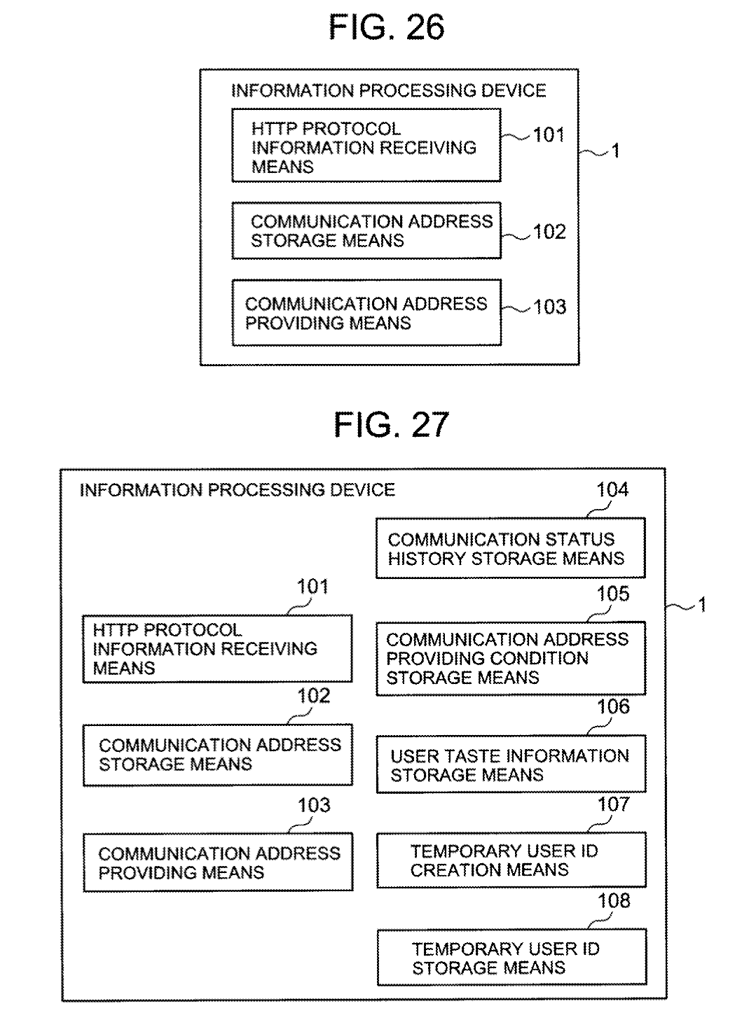

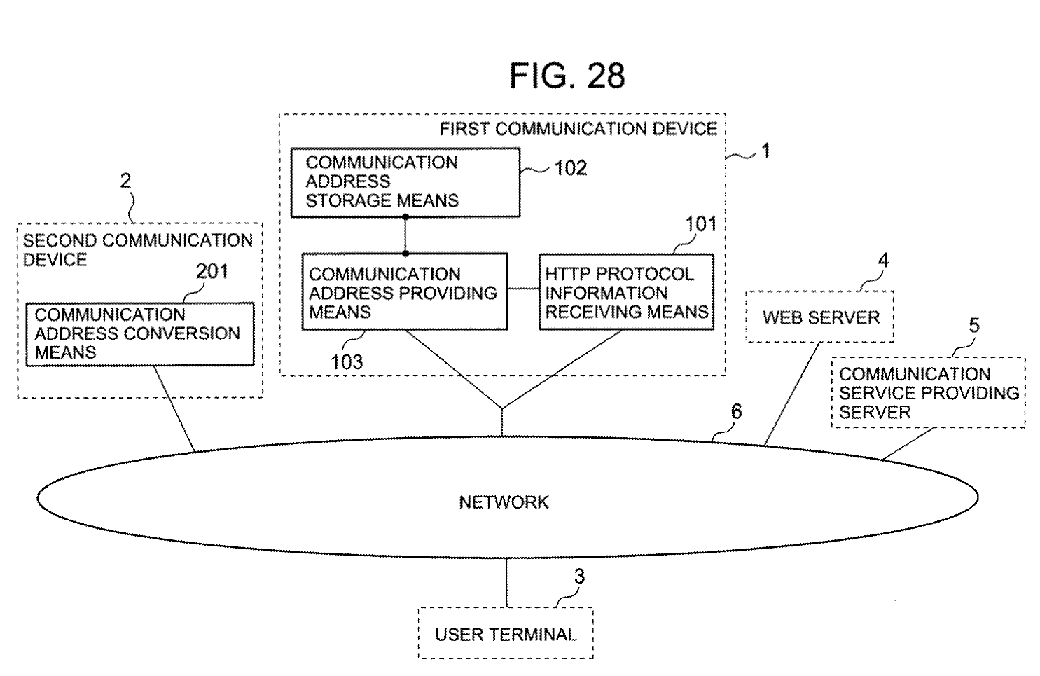

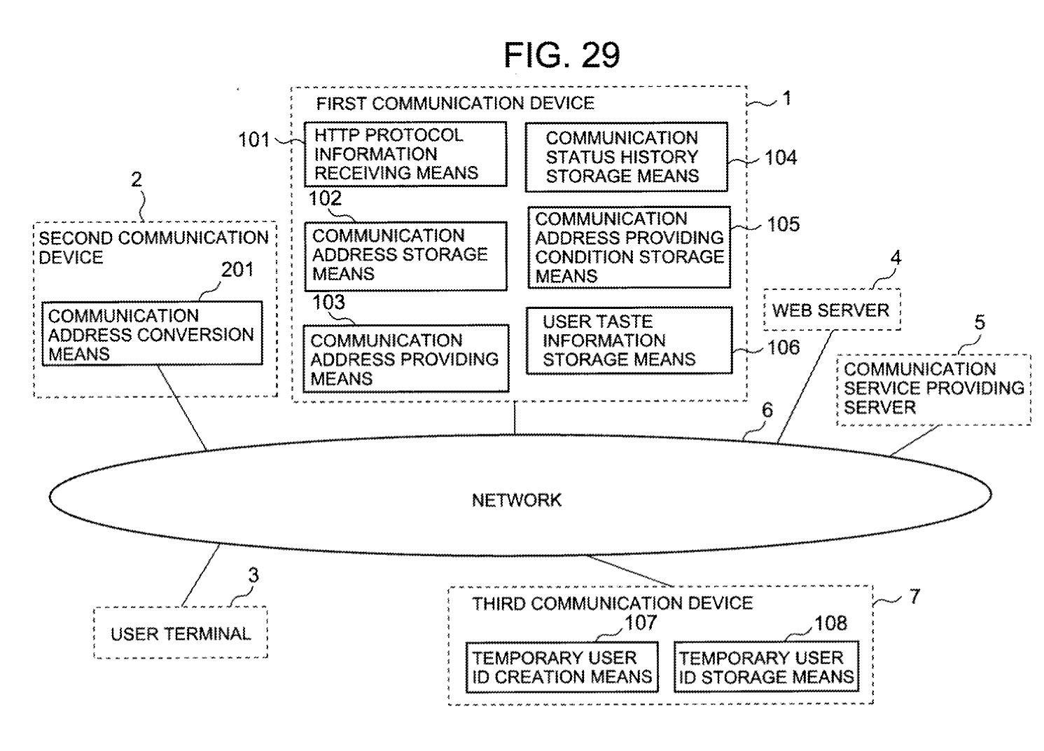

### BRIEF DESCRIPTION OF DRAWINGS

[FIG. 1] It depicts a block diagram showing a configuration example of an anonymous communication address providing system of a first exemplary embodiment.

[FIG. 2] It depicts an explanatory drawing showing an example of data registered with an anonymous communication address management section 33.

[FIG. 3] It depicts an explanatory drawing showing an example of data registered with a communication address management section 21.

[FIG. 4] It depicts a sequence diagram showing an example of operation of the anonymous communication address providing system of the first exemplary embodiment.

[FIG. 5] It depicts a sequence diagram showing an example of operation of the anonymous communication address providing system of the first exemplary embodiment.

[FIG. 6] It depicts a block diagram showing a configuration example of an anonymous communication address providing system according to a second exemplary embodiment.

[FIG. 7] It depicts an explanatory drawing showing an example of data registered with an anonymous communication address providing condition management section 34.

[FIG. 8] It depicts an explanatory drawing showing another example of data registered with the anonymous communication address providing condition management section 34.

[FIG. 9] It depicts an explanatory drawing showing an example of data registered with an anonymous communication address management section 33 in the second exemplary embodiment.

[FIG. 10] It depicts a sequence diagram showing an example of operation of the anonymous communication address providing system of the second exemplary embodiment.

[FIG. 11] It depicts a block diagram showing a configuration example of an anonymous communication address providing system according to a third exemplary embodiment.

[FIG. 12] It depicts an explanatory drawing showing an example of data registered with a user taste information management section 35.

[FIG. 13] It depicts an explanatory drawing showing an example of data registered with the anonymous communication address providing condition management section 34 in the third exemplary embodiment.

[FIG. 14] It depicts a sequence diagram showing an example of operation of the anonymous communication address providing system of the third exemplary embodiment.

[FIG. 15] It depicts a block diagram showing a configuration example of an anonymous communication address providing system according to a fourth exemplary embodiment.

[FIG. 16] It depicts an explanatory drawing showing an example of data registered with an access history management section 36.

[FIG. 17] It depicts an explanatory drawing showing the example of data registered with the access history management section 36.

[FIG. 18] It depicts an explanatory drawing showing an example of data registered with the anonymous communication address providing condition management section 34 in the fourth exemplary embodiment.

[FIG. 19] It depicts an explanatory drawing showing an example of data registered with the anonymous communication address management section 33 in the fourth exemplary embodiment.

[FIG. 20] It depicts a sequence diagram showing an example of operation of the anonymous communication address providing system of the fourth exemplary embodiment.

[FIG. 21] It depicts a sequence diagram showing the example of operation of the anonymous communication address providing system of the fourth exemplary embodiment.

[FIG. 22] It depicts a block diagram showing a configuration example of an anonymous communication address providing system according to a fifth exemplary embodiment.

[FIG. 23] It depicts an explanatory drawing showing an example of data registered with a temporary user ID management section 72.

[FIG. 24] it depicts an explanatory drawing showing an example of data registered with the access history management section 36 in the fifth exemplary embodiment.

[FIG. 25] It depicts a sequence diagram showing an example of operation of the anonymous communication address providing system of the fifth exemplary embodiment.

[FIG. 26] It depicts a block diagram showing the summary of the present invention.

[FIG. 27] It depicts a block diagram showing another configuration example of an information processing device 1 according to the present invention.

[FIG. 28] It depicts a block diagram showing the summary of an anonymous communication address providing system according to the present invention.

[FIG. 29] It depicts a block diagram showing another configuration example of the anonymous communication address providing system according to the present invention.

### DESCRIPTION OF EMBODIMENT

Best modes for carrying out the invention will now be described with reference to the accompanying drawings.

### First Exemplary Embodiment

FIG. 1 is a block diagram showing a configuration example of an anonymous communication address providing system according to a first exemplary embodiment of the present invention. The anonymous communication address providing system shown in FIG. 1 includes a user terminal 10, a mail server 20, an HTTP proxy server 30, a Web server 41, and a communication service providing server 42. The user terminal 10, the mail server 20, the HTTP proxy server 30, the Web server 41, and the communication service providing server 42 are connected through a network 60 such as the Internet or NGN (Next Generation Network), respectively. The connection to the network may be of wired or wireless type.

The user terminal 10 is a personal computer (hereinafter abbreviated as PC) or an information processing terminal such as a cellular phone, having a mail client 12 capable of sending and receiving e-mails (more specifically, a processing section for running a mail client application 12), and a browser 11 for receiving the content of a website or the like (more specifically, a processing section for running a browser application 11).

The mail client 12 is an application for sending and receiving e-mails to and from the mail server 20 to be described later using a protocol such as SMTP (Simple Mail Transfer Protocol) protocol or POP (Post Office Protocol).

The browser 11 is an application for receiving the content of a website from the Web server 41 to be described later using the HTTP (Hypertext Transfer Protocol) protocol and displaying it.

The mail server 20 is a server for sending and receiving e-mails to and from another mail server and mail client using a protocol such as SMTP protocol or POP. In the exemplary embodiment, the system has a communication address management section 21 and a communication address conversion section 22.

Concerning a mail address indicative of a transmission destination or a source of e-mail, the communication address conversion section 22 converts addresses between an anonymous communication address created by an anonymous communication address management section 33 of the HTTP proxy server 30 to be described later and an actual communication address used by the mail client of the user terminal.

In the exemplary embodiment, it is assumed that the format of the anonymous communication address and the actual communication address is a mail address format. Note that the format of the anonymous communication address and the actual communication address is not limited thereto, and it may be a telephone number or the format of SIP-URI (Session Initiation Protocol-Uniform Resource Identifier) used in IMS (IP Multimedia Subsystems).

The communication address management section 21 has an actual communication address used by an application of the user terminal of each user. In the example of the exemplary embodiment, a communication application of the user terminal of each user is a mail client having the actual communication address as a mail address. For example, the communication address management section 21 can be implemented in a database system such as RDBMS (Relational DataBase Management System).

The HTTP proxy server 30 has an HTTP protocol information receiving section 31, an anonymous communication address providing section 32, and the anonymous communication address management section 33.

In addition to the functions provided by common HTTP proxy servers, the HTTP protocol information receiving section 31 obtains information on the user ID and the Web server ID from communication data received from the browser via the HTTP protocol, and detects access status from the browser 11 of a certain user terminal 10 to a certain Web server 41. The obtained user ID and the Web server ID are registered in association with each other while the browser 11 of the certain user terminal 10 is accessing the certain Web server 41.

Here, for example, the functions provided by common HTTP proxy servers include a data cache placed between an intranet and the Internet so that access from a PC in the company to a website will be performed via the HTTP proxy server without fail to ensure high-speed access, and filtering to ensure secure communication.

The user ID is information for identifying the user or the user terminal. For example, if the user terminal is a cellular phone, IMSI (International Mobile Subscriber Identity) as a unique ID assigned by a SIM (Subscriber Identity Module) card to specify a telephone number or a mail address can be used. In the case of a PC, the user ID may be identified using user authentication via the HTTP protocol.

The user authentication via the HTTP protocol is defined in RFC2068 as a standard of the HTTP protocol in the IETF (Internal Engineering Task Force) to work out the standardization of protocol technologies used in the Internet, which is used for intended purposes such as to limit the use of the HTTP proxy server to a specific user alone by urging the user to enter the user name and password on the screen of the PC to specify the user.

The Web server ID is information for identifying the Web server to be described later. For example, as the Web server ID, an FQDN as a fully qualified domain name used on a DNS (Domain Name Server) of the Web server, a domain name as part of the FQDN, a subdomain name, a host name or an IP address of the Web server can be used.

Further, in the exemplary embodiment, although the HTTP proxy server 30 is shown as an example of a communication device for receiving HTTP protocol information, the communication device for receiving HTTP protocol information is not limited thereto, and it may be implemented by DPI (Deep Packet Inspection) for monitoring a protocol from transport layer (layer 4) to application layer (layer 7) in OSI7 layer model.

Based on access status from the user terminal 10 to the Web server 41 detected by the HTTP protocol information receiving section 31, the anonymous communication address providing section 32 causes the anonymous communication address management section 33 to create an anonymous communication address and provide the created anonymous communication address to the communication service providing server 42 or delete the same.

In response to a request from the anonymous communication address providing section 32, the anonymous communication address management section 33 creates an anonymous communication address for a specified combination of the user ID and the Web server ID. While the anonymous communication address is valid, the anonymous communication address management section 33 has the anonymous communication address in association with the combination of the user ID and the Web server ID specified upon creation. For example, the function of having the anonymous communication address can be implemented by a database system such as RDBMS.

Further, in the exemplary embodiment, the anonymous communication address is issued from the HTTP proxy server and converted by the mail server to the actual communication address to provide the anonymous communication address that enables only the service provider to communicate with the user or the user terminal. However, the anonymous communication address can also be provided to both the user terminal and the communication service providing server without associating the anonymous communication address with the actual communication address.

The Web server 41 outputs the content of a website or the like in response to an HTTP request received from the user terminal 10 via the HTTP proxy server 30.

Using the anonymous communication address provided from the anonymous communication address providing section 32 of the HTTP proxy server 30, the communication service providing server 42 sends information such as advertisements toward the user terminal. In the exemplary embodiment, e-mail having the provided anonymous communication address as the destination address is sent to the mail server 20.

Further, in the exemplary embodiment, the communication service providing server 42 is described as a mail sending server for sending advertising mails, but the communication service providing server is not limited thereto and it may be a user terminal. For example, if a person who has started blog, or a blogger, is taken as a service provider, and the user terminal used by the blogger is regarded as a communication service terminal so that an anonymous communication address can also be provided to the user terminal (the terminal of the blogger) to enable communication with a user browsing the blog or a user terminal (a terminal of the user browsing the blog or the blog browser). In such a case, the blogger can provide a communication service, such as to send e-mail from the blogger to the blog browser, without the need for the blog browser to disclose an actual communication address (actual communication address) to the blogger.

FIG. 2 is an explanatory drawing showing an example of data registered with the anonymous communication address management section 33. Shown in FIG. 2 is an example of having, as the structure of data registered with the anonymous communication address management section 33, items of user ID (331), Web server ID (332), and anonymous communication address (333).

FIG. 3 is an explanatory drawing showing an example of data registered with the communication address management section 21. Shown in FIG. 3 is an example of having, as the structure of data registered with the communication address management section 21, items of user ID (211) and actual communication address (212).

In the example of the exemplary embodiment, it is assumed that the mail server 20 and the HTTP proxy server 30 are operated by the same telecommunications carrier such as a cellular phone provider or a fixed-line carrier. Therefore, it is assumed that the user ID (211) registered with the mail server 20 and the user ID (331) registered with the HTTP proxy server 30 indicate the same user or user terminal.

Note that the operator of the mail server 20 and the HTTP proxy server 30 is not limited thereto and it may be different providers. In this case, even if the user ID (211) registered with the mail server 20 and the user ID (331) registered with the HTTP proxy server 30 points out the same user or user terminal, both will take on different values. In such a case, user IDs different in provider may be associated with each other in advance. For example, the provider of the mail server 20 and the provider of the HTTP proxy server 30 may cooperate with each other to present a new anonymous user ID that points out the same user or user terminal and associate the anonymous user ID with the original user ID between both providers. Such a mechanism is commonly employed using SAML (Security Assertion Markup Language) or the like as XML specifications worked out by OASIS as a standard-setting organization to ensure that IDs and passwords are exchanged in security.

Next, a method of detecting access status from the user terminal to the Web server performed by the HTTP protocol information receiving section 31 will be described. In the exemplary embodiment, for ease of explanation, it is assumed that the user terminal 10 uses the function of the browser 11 to use one HTTP Keep Alive for each Web server. Then, the HTTP protocol information receiving section 31 detects a period, during which HTTP Keep Alive indicated by the received communication data is established between the user terminal (browser) and the Web server, as a state of being accessing the website, and disconnection of the HTTP Keep Alive as exit from the website. The HTTP Keep Alive is a function to process two or more HTTP requests in one TCP (Transmission Control Protocol) connection, and the specifications are defined in RFC2616.

As another method of detecting the state of being accessing the website or exit therefrom, the access to the website or exit from the website may be detected in cooperation with single sign-on in which temporary user authentication allows the user to access all permitted Web servers. SAML or the like already mentioned above can be employed to implement single sign-on.

For example, respective user IDs of the telecommunications carrier (here, the operator of the HTTP proxy server and the mail server) and the Web service provider (Web server operator or operator of the communication service providing server) are connected beforehand by a technique called ID Federation. In this regard, a temporary assumed user ID is issued. Further, when a login operation has been performed from the user terminal to the telecommunications carrier, that effect is registered on the telecommunications carrier side. After that, the assumed user ID is specified from the Web service provider to the telecommunications carrier in response to access from the user terminal to the Web service provider to make an inquiry about whether the user is a user whose login has been enabled. The telecommunications carrier presents, to the Web service provider, the login status connected to the assumed user ID.

In such a single sign-on operation, the user terminal is required to log in under single sign-on as a prerequisite to access the HTTP proxy server, and the inquiry about login status from the Web service provider (more specifically, the Web server) to the telecommunications carrier (more specifically, the HTTP proxy server) can lead to recognition of the start of access to the website.

Single sign-on includes a single sign-off operation for resolving the login status collectively, so that when single sign-off is performed, it is possible to determine exit from the website.

The method of detecting exit from the website is not limited to those mentioned above. When the user terminal is a wireless communication device such as a cellular phone, it may be determined from cutting off a wireless link detected in a UTRAN (UMTS Terrestrial Radio Access Network) for controlling the wireless link between the user terminal and a wireless base station. Further, the exit may be determined when timekeeping means detects the transfer of the HTTP protocol has not been performed for a predetermined period of time as the access status of the HTTP protocol. Furthermore, the exit may be detected by a method for receiving, from the user terminal, a signal indicative of the exit separately.

Next, the operation of the exemplary embodiment will be described. FIG. 4 and FIG. 5 are sequence diagrams showing an example of operation of the anonymous communication address providing system according to the exemplary embodiment. FIG. 4 is a sequence diagram showing an operation example related to issuing an anonymous communication address. FIG. 5 is a sequence diagram showing an operation example related to the expiration of the anonymous communication address. In FIG. 4 and FIG. 5, note that messages indicated by the broken arrows are responses to requests received.

As shown in FIG. 4, the browser 11 (more specifically, a browser application execution section 1 I) of the user terminal 10 first sends an HTTP request to the Web server 41 to access a website specified according to user's operations (step S101). In this example, a case is taken as an example in which access to URL “http://www.restaurant.co.jp/booking_service.html” is performed from the browser 11 of the user terminal 10 to which “user0001” is assigned as the user ID.

The HTTP request sent from the user terminal 10 is received by the HTTP protocol information receiving section 31 of the HTTP proxy server 30, rather than being received directly by the Web server 41. As a method of going through the HTTP proxy server, for example, the address of the HTTP proxy server or a port number may be specified directly in the browser's settings or it may be implemented as a transparent proxy configured such that a specific port number is monitored at a router or a bridge to redirect the protocol to the downstream HTTP proxy server in order to make the HTTP proxy server available without special browser's settings.

When receiving communication data (here, an HTTP request) via the HTTP protocol from the user terminal 10 to the Web server 41, the HTTP protocol information receiving section 31 of the HTTP proxy server 30 obtains the user ID and the Web server ID specified under the HTTP protocol of the received communication data, and detects that the communication data is an HTTP request to detect the access status to the Web server 41 identified by the Web server ID also obtained from the user terminal 10 (or a user terminal used by the user) identified by the obtained user ID as being accessing the website (step S102). Then, access status in the combination is notified to the anonymous communication address providing section 32 through a website access notification including the obtained user ID and Web server ID (step S103). In this example, a website access notification including “user0001” as the user ID and “www.restaurant.co.jp” as an FQDN of the URL “http://www.restaurant.co.jp/booking_service.html” as the Web server ID is output to the anonymous communication address providing section 32.

Note that SOAP (Simple Object Access Protocol) based on XML (Extensible Markup Language) and HTTP may be employed to exchange data between the HTTP protocol information receiving section 31 and the anonymous communication address providing section 32.

After that, the HTTP protocol information receiving section 31 sends the HTTP request to the Web server 41 as the access destination on behalf of the browser 11 of the user terminal 10 as the source (step S104).

The Web server 41 receives the HTTP request from the user terminal 10 via the HTTP proxy server 30. The Web server 41 analyzes the received HTTP request and sends back the required content of the website or the like as an HTTP response (step S105).

The HTTP response sent from the Web server 41 is received by the HTTP protocol information receiving section 31 of the HTTP proxy server 30. The HTTP protocol information receiving section 31 sends the HTTP response received from the Web server 41 back to the browser of the user terminal 10 as the original source (step S106).

When receiving the HTTP response, the browser 11 of the user terminal 10 displays the content of the website or the like included in the HTTP response.

On the other hand, when receiving the website access notification from the HTTP protocol information receiving section 31, the anonymous communication address providing section 32 specifies the user ID and Web server ID included in the website access notification and requests the anonymous communication address management section 33 to create an anonymous communication address. In this example, the request for creation of an anonymous communication address including the user ID “user0001” and the Web server ID “www.restaurant.co.jp” included in the received website access notification is sent to the anonymous communication address management section 33 (step S107).

If any anonymous communication address is not associated with the combination of the user ID and the Web server ID included in the request yet, the anonymous communication address management section 33 that received the request for creation of an anonymous communication address creates a new anonymous communication address (step S108). For example, the anonymous communication address management section 33 can associate the new anonymous communication address with the combination of the specified user ID and Web server ID. In response to receiving the request for an anonymous communication address, the anonymous communication address to be associated may be created using random numbers or selected from unused anonymous communication addresses prepared in advance. In this example, suppose that an anonymous communication address “temp0002@carrier.com” is associated with the combination of the user ID “user0001” and the Web server ID “www.restaurant.co.jp.”

Upon completion of the association of the anonymous communication address, the anonymous communication address management section 33 sends back, to the anonymous communication address providing section 32, an anonymous communication address creation response including the anonymous communication address (in this example, “temp0002@carrier.com”) associated with the specified user ID and Web server. ID (step S109). When receiving the request for creation of an anonymous communication address, if an anonymous communication address has already been associated with the specified user ID and Web server ID, the anonymous communication address management section 33 can send back a message indicating that the anonymous communication address has been provided.

The anonymous communication address providing section 32 that received the anonymous communication address creation response provides the created anonymous communication address to the communication service providing server 42 associated in advance with the Web server ID specified in the creation request. In this example, the anonymous communication address providing section 32 sends, to the communication service providing server 42 determined from the Web server ID, an anonymous communication address issuing notification including the anonymous communication address “temp0002@carrier.com” (step S110). For example, the communication service providing server 42 as the destination of the anonymous communication address may be determined based on a rule defined to automatically create the FQDN of the communication service providing server 42 from the FQDN of the Web server ID.

For example, when the Web server ID is the FQDN, an automated creation rule to replace “www” as the host name with “pseudonym” can be defined to determine “pseudonym.restaurant.co.jp” as the FQDN of a communication service providing server from the Web server ID “www.restaurant.co.jp.”

Further, for example, when the Web server ID is an IP address like “192.168.122.139,” a TCP port number “:8090” may be limited with respect to the IP address of the Web server ID to present an automated creation rule to set the address of the communication service providing server as the notification destination (in this example, “192.168.122.139:8090”).

The communication service providing server 42 receives the anonymous communication address issuing notification from the anonymous communication address providing section 32 and enables use of the anonymous communication address included in the issuing notification as the address of the user who shows interest in the Web page. For example, the communication service providing server 42 may provide a communication service such as advertising mails using the anonymous communication address. In this example, the anonymous communication address “temp0002@carrier.com” is specified and sent as the e-mail destination address (step S111).

E-mails sent from the communication service providing server 42 are received by the mail server 20. Since the e-mail destination address is the anonymous communication address, the communication address conversion section 22 in the mail server 20 that received the e-mail converts it to an actual communication address: In this example, the communication address conversion section 22 obtains the anonymous communication address from the e-mail destination address, and sends a request for the user ID, for which the obtained anonymous communication address (here, “temp0002@carrier.com”) is specified, to the anonymous communication address management section 33 of the HTTP proxy server 30 (step S112).

The anonymous communication address management section 33 searches for information associated with an anonymous communication address, a user ID, and a Web server ID registered therewith, settles the user 1D “user0001” corresponding to the specified anonymous communication address “temp0002@carrier.com,” and sends back, to the communication address conversion section 22 as the requester, a user ID response including the obtained user ID “user0001” (step S113). If there is no corresponding user ID, it notifies the communication address conversion section 22 that the obtaining of the user ID has failed.

When receiving the user ID response, the communication address conversion section 22 settles an actual communication address from the user ID in response to the settlement of the user ID. In this example, the user ID (here, “user0001”) included in the received user ID response is specified, and a request for an actual communication address is sent to the communication address management section 21 (step S114). When receiving a response indicating that the obtaining of the user ID has failed is received, it can notify the communication service providing server 42 (source of the mail) that the transmission of the mail has failed and end the processing.

The communication address management section 21 that received the request for an actual communication address settles an actual communication address using the specified user ID “user0001” as a search key, and sends back, to the communication address conversion section 22 as the requester, a response on the actual communication address including the obtained actual communication address (step S115). In this example, suppose that an actual communication address “alice@carrier.com” is registered with the communication address management section 21 in association with the user ID “user0001.” In this case, the communication address management section 21 sends back, to the communication address conversion section 22, an actual communication address response including “alice@carrier.com” as the actual communication address (step S115).

Receiving the actual communication address response from the communication address management section 21, the communication address conversion section 22 converts the anonymous communication address “temp0002@carrier.com” given as the received e-mail destination address into the actual communication address “alice@carrier.com,” and delivers an e-mail to the user terminal 10 identified by the actual communication address (steps S116 and S117).

On the user terminal 10, the mail client 12 receives the e-mail and displays the content on a display. This enables the user to receive an information providing service from the service provider related to the website in which the user shows interest without disclosing the actual communication address.

The anonymous communication address provided to the service provider may be invalidated as follows: For example, when the user finishes browsing the website on the browser 11, the browser 11 of the user terminal 10 sends a TCP disconnection notification to the HTTP proxy server 30 (step S201 in FIG. 5).

When receiving communication data (here, TCP disconnection notification) via the HTTP protocol from the user terminal 10 to the Web server 41, the HTTP protocol information receiving section 31 of the HTTP proxy server 30 obtains the user ID and the Web server ID specified under the HTTP protocol of the communication data received, and detects that the communication data is the TCP disconnection notification to detect the access status to the Web server 41 identified by the Web server ID also obtained from the user terminal 10 (or a user terminal used by the user) identified by the obtained user ID as exit (step S202). Then, access status in the combination is notified to the anonymous communication address providing section 32 through the website exit notification including the obtained user ID and Web server ID. In this example, the website exit notification including the user ID “user0001” and the Web server ID “www.restaurant.co.jp” currently associated with the TCP session to be disconnected is sent to the anonymous communication address providing section 32 (step S203).

Further, the HTTP protocol information receiving section 31 disconnects the TCP session between the user terminal 10 and the Web server 41. Here, a TCP disconnection notification is sent to the Web server 41 (step S204). The procedure for perfect disconnection of the TCP session is performed by sending end signals called FIN from both devices participating in the TCP session, but the description thereof will be omitted here.

The anonymous communication address providing section 32 that received the website exit notification requests the anonymous communication address management section 33 to delete the anonymous communication address currently associated with the combination of the notified user ID and Web server ID. In this example, a request for deletion of the anonymous communication address including the notified user ID “user0001” and Web server ID “www.restaurant.co.jp” is sent to the anonymous communication address management section 33 (step S205).

The anonymous communication address management section 33 that received the request for deletion of the anonymous communication address deletes the anonymous communication address currently associated with the combination of the user ID (here, “user0001”) and the Web server ID (here, “www.restaurant.co.jp”) included in the received request for deletion of the anonymous communication address from information registered therewith, and the deletion result is sent back to the anonymous communication address providing section 32 (step S205). At this time, the anonymous communication address management section 33 may delete only the information on the associated anonymous communication address or the entire record (line) including the user ID, the Web server ID, and the anonymous communication address.

As described above, according to the exemplary embodiment, the anonymous communication address can be provided to the communication service providing server associated with the Web page hosted by the Web server based on access status of the user terminal 10 to the Web server using the browser 11 under the HTTP protocol.

This enables the service provider operating the communication service providing server to deliver advertisements to the user terminal by e-mail or the like using the anonymous communication address only while the user terminal is accessing the website. This also enables the user to receive e-mails such as advertisements from the service provider (e.g., the service provider operating the Web page) associated with the Web page in which the user shows interest without disclosing personal information.

### Second Exemplary Embodiment

Next, a second exemplary embodiment of the present invention will be described. In this exemplary embodiment, in response to an HTTP request sent from the user terminal, the HTTP proxy server sets whether the anonymous communication address is to be provided and a service provider as the destination to which the anonymous communication address is provided.

FIG. 6 is a block diagram showing a configuration example of an anonymous communication address providing system according to the second exemplary embodiment. The anonymous communication address providing system shown in FIG. 6 is different from the first exemplary embodiment in that the HTTP proxy server 30 further has an anonymous communication address providing condition management section 34.

The anonymous communication address providing condition management section 34 has information on the Web server as the access source as conditions for providing an anonymous communication address. For example, the anonymous communication address providing condition management section 34 can be implemented in a database system such as RDBMS. FIG. 7 is an explanatory drawing showing an example of data registered with the anonymous communication address providing condition management section 34. Shown in FIG. 7 is an example of having, as the structure of data registered with the anonymous communication address providing condition management section 34, items of Web server ID (341) and address of communication service providing server (342).

The address of communication service providing server (342) registers a network address of a communication service providing server as an anonymous communication address providing destination. Note that as the address of communication service providing server (342), a network address capable of receiving the anonymous communication address is registered. In this example, FQDN and IP address are stored in the address of communication service providing server. Of course, the address of the communication service providing server is not limited thereto, and it can be stored in a data format of a Web service description language such as WSDL (Web Services Description Language) indicative of the format of messages used for communication destination addresses or services in SOAP or protocols.

In the example shown in FIG. 7, the Web server ID as a trigger to provide the anonymous communication address is directly associated with the address of the communication service providing server as the anonymous communication address providing destination to narrow down Web servers as triggers to provide the anonymous communication address. The method of narrowing down Web servers is not limited thereto, and information indicating whether to provide or not may be associated with the Web server ID, for example. An ID indicative of the provider of the Web server may also be associated.

Further, for example, as shown in FIG. 8, the Web server ID as a trigger to provide the anonymous communication address may be associated with an ID indicative of a provider operating the communication service providing server as the anonymous communication address providing destination. FIG. 8 is an explanatory drawing showing another example of data registered with the anonymous communication address providing condition management section 34. Shown in FIG. 8 is an example of having, as the structure of data registered with the anonymous communication address providing condition management section 34, items of Web server ID (341), service provider ID (343), and address of communication service providing server (342).

The service provider ID (343) is information for identifying a provider to permit providing of a communication service in response to access to the website indicated by the Web server ID, i.e. information for identifying a provider operating the communication service providing server as the anonymous communication address providing destination. This service provider may be either the same as or different from the provider of the Web server. As in this example, it is possible to associate one service provider ID “service0001” with plural Web server IDs “www.restaurant1.co.jp” and “www.restaurant2.co.jp.” It is also possible to associate plural service providers with one Web server ID. Further, in this example, the linefeed code is introduced as a delimiter for storing plural Web server IDs to represent the Web server IDs. Of course, the delimiter is not limited thereto, and it may be the blank character, a punctuation mark, a special character, or the like as long as it is a separator.

FIG. 9 is an explanatory drawing showing an example of data registered with the anonymous communication address management section 33 in the exemplary embodiment. In the exemplary embodiment, as shown in FIG. 9, the anonymous communication address management section 33 may be of data structure having, instead of Web server ID (332), an item of address of communication service providing server (332B) used by the anonymous communication address providing condition management section 34 as communication destination identification information. It can also be the service provider ID rather than the address of the communication service providing server.

Further, in the exemplary embodiment, the anonymous communication address providing section 32 determines whether the Web server is a Web server that triggers the anonymous communication address based on the information registered with the anonymous communication address providing condition management section 34 to provide the anonymous communication address, rather than to provide the anonymous communication address unconditionally from information on the Web server, on which the website is hosted, in response to the access from the user terminal to the website.

Next, the operation of the exemplary embodiment will be described. FIG. 10 is a sequence diagram showing an example of operation of the anonymous communication address providing system of the exemplary embodiment. In this example, since the operations of the user terminal 10, the Web server, and the HTTP protocol information receiving section 31 after sending an HTTP request until receiving information on the website from the Web server (steps S301 to 306) are the same as those in the first exemplary embodiment (steps S101 to 106), the description thereof will be omitted. In this example, a case is taken as an example in which the user terminal with the user ID “user0001” accesses the Web server with the Web server ID “www.restaurant.co.jp.”

In step S307, the anonymous communication address providing section 32 that received a website access notification from the HTTP protocol information receiving section 31 sends the anonymous communication address providing condition management section 34 a request for the address of a communication service providing server specifying a Web server ID (here, “www.restaurant.co.jp”) included in the website access notification. If data registered with the anonymous communication address providing condition management section 34 has the data structure as shown in FIG. 8, it may be a request for a service provider ID.

The anonymous communication address providing condition management section 34 that received the request for the address of a communication service providing server determines, from data registered, the address of a communication service providing server associated with the specified Web server ID, and sends it back to the anonymous communication address providing section 32 as a response on the address of the communication service providing server (step S308). For example, in the example shown in FIG. 7, the address of the communication service providing server “adagency.restaurant.co.jp” can be determined for the Web server ID “www.restaurant.co.jp” and sent back.

At this time, in the anonymous communication address providing condition management section 34, if the address of the communication service providing server corresponding to the Web service ID notified from the anonymous communication address management section 33 does not exist, the effect that the address of the corresponding communication service providing server does not exist can be sent back to the anonymous communication address providing section 32.

If the address of the corresponding communication service providing server exists, the anonymous communication address providing section 32 that received the response on the address of the communication service providing server can provide the anonymous communication address toward the address of the communication service providing server. Note that the anonymous communication address can be provided by sending the anonymous communication address created by the anonymous communication address management section 33 to the address of the communication service providing server included in the response on the address of the communication service providing server. Although the creation of the anonymous communication address may be basically the same as that in the first exemplary embodiment, the address of the communication service providing server (or the service provider ID) is specified and sent in step S309, rather than specifying the Web server ID in the request for creation of the anonymous communication address. In addition, the anonymous communication address management section 33 can associate the anonymous communication address with the combination of the user ID and the address of the communication service providing server (or the service provider ID) and send back the associated anonymous communication address (steps S310 and S311). When receiving the request for the anonymous communication address, if there exists an anonymous communication address for the combination of user ID and address of the communication service providing server (or the service provider ID) already specified, the anonymous communication address management section 33 can send back a response indicating that the anonymous communication address has already been provided.

On the other hand, if the address of the address of a corresponding communication service providing server does not exist in the response on the address of the communication service providing server from the anonymous communication address providing condition management section 34, the anonymous communication address providing section 32 ends the processing without performing subsequent processing for providing the anonymous communication address. This can avoid handling access to a Web server being not registered with the anonymous communication address providing condition management section 34 as a trigger to provide the anonymous communication address.

Further, when the effect that the anonymous communication address has already been provided is sent back from the anonymous communication address management section 33, the anonymous communication address providing section 32 ends the processing without providing any anonymous communication address in the processing (process). This is because it is unnecessary to provide the anonymous communication address again to the same user. The subsequent operations are the same as those in the first exemplary embodiment.

As described above, according to the exemplary embodiment, a service provider as the anonymous communication address providing destination can be distinguished from service providers that are not the anonymous communication address providing destination among accesses via the HTTP protocol from the user terminal 10 to the Web server using the browser 11.

Further, since the association between the Web server as the access destination and the communication service providing server as the notification destination can be set freely on the system operator side, even if the service provider as the anonymous communication address providing destination operates the Web server using plural FQDNs, anonymous communication addresses can be prevented from being provided redundantly to the same service provider. The other points are the same as those in the first exemplary embodiment.

### Third Exemplary Embodiment

Next, a third exemplary embodiment of the present invention will be described. In the exemplary embodiment, a service provider as the anonymous communication address providing destination is decided on the HTTP proxy server based on user taste information as well as the access status to the website.

FIG. 11 is a block diagram showing a configuration example of an anonymous communication address providing system according to the third exemplary embodiment. The anonymous communication address providing system shown in FIG. 11 is different from that of the second exemplary embodiment in that the HTTP proxy server 30 further has a user taste information management section 35.

The user taste information management section 35 has user taste information. For example, the user taste information management section 35 can be implemented in a database system such as RDBMS. FIG. 12 is an explanatory drawing showing an example of data registered with the user taste information management section 35. Shown in FIG. 12 is an example of having, as the structure of data registered with the user taste information management section 35, items of user ID (351) and service category (352).

Here, the user ID (351) includes user IDs obtained by the HTTP protocol information receiving section 31 as information for identifying users as the users in the system or user terminals. The service category (352) is information indicative of information on service categories in which each user is interested. Shown in FIG. 12 is an example, where “dinner, car, camera, heavenly body” are registered as the information service categories in which user ID “user0001” is interested. In the example shown in FIG. 12, “,” code is introduced as a delimiter for storing plural service categories to represent the service categories. Of course, the delimiter is not limited thereto, and it may be the blank character, a punctuation mark, a special character, or the like as long as it is a separator.

FIG. 13 is an explanatory drawing showing an example of data registered with the anonymous communication address providing condition management section 34 in the exemplary embodiment. In the exemplary embodiment, as shown in FIG. 13, the anonymous communication address providing condition management section 34 further adds an item of service category (344) of a website indicated by each Web server ID as a condition for providing an anonymous communication address. The service category (344) is information indicative of the categories of information services provided on the website indicated by the Web server ID. For example, it shows the categories in each of which the website provides a service for providing information.

Further, in response to access from a user terminal to a website, the anonymous communication address providing section 32 provides an anonymous communication address only when any of the service categories of the website matches user taste information on the user who has accessed the website.

Next, the operation of the exemplary embodiment will be described. FIG. 14 is a sequence diagram showing an example of operation of the anonymous communication address providing system of the exemplary embodiment. In this example, since the operations of the user terminal 10, the Web server, and the HTTP protocol information receiving section 31 after sending an HTTP request until receiving information on the website from the Web server are also the same as those in the first exemplary embodiment (steps S101 to 106), the description thereof will be omitted. In this example, a case is taken as an example in which the user terminal with the user ID “user0001” accesses the Web server with the Web server ID “www.restaurant.co.jp.”

The anonymous communication address providing section 32 that received a website access notification from the HTTP protocol information receiving section 31 first checks for conditions for providing an anonymous communication address to the Web server as the access destination. In this example, a condition request specifying the Web server ID (here, “www.restaurant2.co.jp”) included in the website access notification is sent to the anonymous communication address providing condition management section 34 (step S401).

The anonymous communication address providing condition management section 34 that received the condition request determines, from data registered, the address of a communication service providing server (342) associated with the specified Web server ID and a service category (344), and sends it back to the anonymous communication address providing section 32 as a condition response (step S402). For example, in the example shown in FIG. 13, the address of the communication service providing server “adagency.restaurant.co.jp” and the service category “dinner, lunch” can be determined for the Web server ID “www.restaurant.co.jp” and sent back.

The anonymous communication address providing section 32 specifies a user ID included in a website access notification from the user taste information management section 35 and sends a request for user taste information (step S403). If there exists no communication service providing server in the response from the anonymous communication address providing condition management section 34, the processing may be ended without sending the request for user taste information.

The user taste information management section 35 that received the request for user taste information determines a service category (352) associated with the specified user ID “user0001” and sends it back to the anonymous communication address providing section 32 as a response on user taste information (step S404). For example, in the example shown in FIG. 13, service categories “dinner, car, camera, heavenly body” are determined for the user ID “user0001” and sent back.

The anonymous communication address providing section 32 compares information on the service categories of the Web server included in the condition response with information on the service categories included in the response on user taste information as those in which the user shows interest to extract a service category matching between both (step S405). In this example, the matching service category is “dinner.”

Then, as a result of the comparison, if a matching service category exists, the anonymous communication address providing section 32 requests the anonymous communication address providing section 32 to create an anonymous communication address for a combination of the user ID and the communication service providing server. Note that operations following the creation of an anonymous communication address are the same as those in the second exemplary embodiment. On the other hand, if no matching service category exists, the processing can be ended without performing a sequence of subsequent operations related to providing an anonymous communication address.

In the exemplary embodiment, when providing an anonymous communication address to a communication service providing server, the anonymous communication address providing section 32 may specify a service category for which the anonymous communication address is available. For example, the information providing service may be made available for only a service category matching between user's service categories registered as categories in which the user shows interest and the service categories of the service provider to specify the service category (in this example, “dinner”).

As described above, according to the exemplary embodiment, since a service provider as the anonymous communication address providing destination is decided based further on the user taste information, information on a category in which the user shows interest among the communication services using the anonymous communication address can be provided.

### Fourth Exemplary Embodiment

Next, a fourth exemplary embodiment of the present invention will be described. In the exemplary embodiment, a history of access to a website via the HTTP protocol is registered on the HTTP proxy server, and based on the access history, an anonymous communication address is issued in response to a request from the communication service providing server.

FIG. 15 is a block diagram showing a configuration example of an anonymous communication address providing system according to the fourth exemplary embodiment. The anonymous communication address providing system shown in FIG. 15 is different from the third exemplary embodiment in that the HTTP proxy server 30 further has an access history management section 36.

The access history management section 36 has, as a history, access status from the user terminal to the Web server detected by the HTTP protocol information receiving section 31. For example, the access history management section 36 can be implemented in a database system such as RDBMS. FIG. 16 and FIG. 17 are explanatory drawings showing an example of data registered with the access history management section 36. Shown in FIG. 16 and FIG. 17 is an example of having, as the structure of data registered with the access history management section 36, items of website access time (361), website exit time (362), user ID (363), and Web server ID (364). In FIG. 16, “--” in the website exit (362) indicates that the access to the website continues connected.

Here, the website access time (361) is the date and time when the user starts accessing (connecting the access to) the website. For example, this may be the date and time when the HTTP protocol information receiving section 31 detects the access to the website. Further, for example, this may be the date and time when the anonymous communication address providing section 32 receives a website access notification from the HTTP protocol information receiving section 31.

The website exit time (362) is the date and time when the user disconnects the access to the website. For example, this may be the date and time when the HTTP protocol information receiving section 31 detects exit from the website. Further, for example, this may be the date and time when the anonymous communication address providing section 32 receives a website exit notification from the HTTP protocol information receiving section 31.

The user ID (363) is information for identifying the user or the user terminal. The Web server ID (364) is information for identifying the Web server.

FIG. 18 is an explanatory drawing showing an example of data registered with the anonymous communication address providing condition management section 34 in the exemplary embodiment. In the exemplary embodiment, as shown in FIG. 18, the anonymous communication address providing condition management section 34 further adds an item of number of times available depending on access time (345) as a condition for providing the anonymous communication address. The number of times available depending on access time (345) is information indicative of the number of times the anonymous communication address is available and determined depending on the access time to the website that was a trigger to provide the anonymous communication address.

FIG. 19 is an explanatory drawing showing an example of data registered with the anonymous communication address management section 33 in the exemplary embodiment. When the number of available times is set in the anonymous communication address providing condition management section 34 depending on the access time as a condition for providing an anonymous communication address, the anonymous communication address providing section 32 creates an anonymous communication address and further has an item of number of available times (334) when associating it with the combination of the user ID and the address of the communication service providing server (or the service provider ID). Depending on the value of this number of available times (334), it is indicated how long the registered anonymous communication address is available.

The anonymous communication address providing section 32 issues the anonymous communication address in response to a request from the communication service providing server, rather than issuing the anonymous communication address in response to the access from the user terminal 10 to the website as a trigger. In doing so, it is determined, based on the access history registered with the access history management section 36, to which user the anonymous communication address is provided and the limited use of the anonymous communication address to be provided.

Next, the operation of the exemplary embodiment will be described. FIG. 20 and FIG. 21 are sequence diagrams showing an example of operation of the anonymous communication address providing system of the exemplary embodiment. FIG. 20 is a sequence diagram showing an example operation related to the registration of the access history. FIG. 21 is a sequence diagram showing an example operation related to providing an anonymous communication address.

The operation related to the registration of the access history will first be described. In the exemplary embodiment, as shown in FIG. 20, when an HTTP request is sent toward the Web server to obtain information on a website through the browser 11 of the user terminal 10 (step S501), the HTTP protocol information receiving section 31 of the HTTP proxy server 30 that received the HTTP request obtains a user ID and a Web server ID from the received HTTP request, detects the access to the website (step S502), and outputs a website access notification to the access history management section 36 (step S503). In this example, it is assumed that the user ID “user0001” and the Web server ID “www.restaurant.co.jp” are obtained from the HTTP request.

Like in the first exemplary embodiment, the HTTP protocol information receiving section 31 sends an HTTP request to the Web server 41 as the access destination on behalf of the browser 11 of the user terminal 10 (step S504). The subsequent operations of the Web server 41 and the user terminal 10 regarding the HTTP request (steps S505 and S506) are the same as those in the first exemplary embodiment.

On the other hand, the access history management section 36 that received the website access notification uses the notified user ID and Web server ID to create and store history information in a storage area with the current date and time set as website access time (361) (step S507). At this point, the website exit time (362) is empty (see FIG. 16).

When the user finishes browsing the website on the browser 11, the user terminal 10 sends the HTTP proxy server 30 a TCP disconnection notification (step S601).

In the HTTP proxy server 30 that received the TCP disconnection notification, the HTTP protocol information receiving section 31 disconnects the TCP session, detects the access status to the website as exit (step S602), and sends the access history management section 36 a website exit notification with the obtained user ID and Web server ID specified (step S603). Further, TCP disconnection notification is sent to the Web server 41 (step S604).

The access history management section 36 that received the website exit notification uses the notified user ID and Web server ID to search for history information (line) on the same combination currently connected from the access history registered, and store the current date and time as the website exit time (362) (step S605). Whether it is currently being accessing or not may be determined depending on whether the value of the website exit time (363) is empty or not.

Next, the operation related to providing an anonymous communication address will be described. As shown in FIG. 21, an anonymous communication address is provided in the exemplary embodiment in response to the transmission of a request for the anonymous communication address from the communication service providing server 42 to the anonymous communication address providing section 32 of the HTTP proxy server 30. The timing of the transmission of the request for the anonymous communication address from the communication service providing server 42 is optional.

In step S701, when a request for an anonymous communication address including the address of the communication service providing server 42 (or the service provider ID) is sent from the communication service providing server 42, the anonymous communication address providing section 32 of the HTTP proxy server 30 decides, based on the access history registered with the access history management section 36, to which user the anonymous communication address is provided, how many times the use of the anonymous communication address to be provided is available, and so on. In the following, a case is taken as an example in which “adagency.restaurant.co.jp” is specified as the address of the communication service providing server.

First, the anonymous communication address providing section 32 specifies the address of a communication service providing server included in the request for the anonymous communication address, and sends the anonymous communication address providing condition management section 34 a condition request for setting the address of the communication service providing server as the providing destination (step S702). Here, the conditions include at least Web server ID information with the address of the communication service providing server set as the providing destination.

The anonymous communication address providing condition management section 34 that received the condition request obtains the Web server ID (341) for which the address of the specified communication service providing server is registered as the providing destination (342), the service category (344), and the number of available times depending on access time (345), and sends them back to the anonymous communication address providing section 32 as a condition response (step S703). For example, in the example shown in FIG. 18, a response on provided information including the Web server ID “www.restaurant.co.jp,” the service category “dinner, lunch,” and the number of available times depending on access time “15 minutes” is sent.

The anonymous communication address providing section 32 that received the reply specifies a Web server ID included in the response on provided information, and sends the access history management section 36 a request for an access history related to a website specified by the Web server ID (step S704).

The access history management section 36 that received the request for the access history obtains an access history matching with the specified Web server ID from the history of accesses registered, and sends it back to the anonymous communication address providing section 32 as a response on the access history (step S705). The response on the access history has only to include information to allow the anonymous communication address providing section 32 as the return destination to specify the user ID as a person to access and the access time (access time) to the website registered in the history. For example, in the example shown in FIG. 17, information on the first record and information on the fourth record have only to be notified as the history of accesses in which the Web server ID matches with “www.restaunrant.co.jp.” If the access continues, the access time may be specified by the duration up to this time.

The anonymous communication address providing section 32 that received the response on the access history calculates a total access time to the Web server indicated by the specified Web server ID for each user ID as a person who accesses the Web server from among the history of accesses obtained from the response on the access history. In this example, for the user ID “user0001,” 32 minutes is determined as the access time by summing up 17 minutes (2008/07/23 19:49-2008/07/23 19:32) calculated as the access time from the information on the first record and 15 minutes (2008/07/24 19:47-2008/07/24 19:32) calculated as the access time from the information on the fourth record.

Then, based on the determined total access time (in this example, 32 minutes) and the number of available times depending on access time (345) obtained from the anonymous communication address providing condition management section 34, the number of available times of the anonymous communication address to be provided is decided. In this example, since the number of available times depending on the access time associated with the Web server ID “www.restaurant.co.jp” is 15 minutes, the number of available times of the anonymous communication address is defined as two as a result of dividing 32 minutes by 15 minutes (where all digits to the right of the decimal point is discarded). Here, if the determined number of available times is less than one, the anonymous communication address corresponding to the user ID is not provided (step S706). In other words, user IDs for which the determined number of available times is one or more are decided to be candidates for the anonymous communication address.

Next, the anonymous communication address providing section 32 specifies user IDs as the candidates for the anonymous communication address, which are determined by the access time indicated in the access history, and sends a request for user taste information (step S707). In this example, a request for user taste information with the user ID “user0001” specified is sent. When there are two or more user IDs as the candidates for the anonymous communication address, a request for user taste information with all the user IDs specified may be sent, or two or more requests for user taste information may be sent on a user ID basis.

The user taste information management section 35 that received the request for user taste information searches for the service category (352) associated with the notified user ID and sends it back (step S708).

The anonymous communication address providing section 32 that received the reply compares the service categories of the Web server associated with the communication service providing server as the requester, which is received from the anonymous communication address providing condition management section 34, with service categories associated with each of the user IDs decided to be candidates, which are received form the user taste information management section 35, to check whether there is a matching category (step S709). If there is no matching category, the anonymous communication address is not provided to the user ID.

If there is any matching category, the anonymous communication address providing section 32 specifies the user ID with the matching category, the address of the communication service providing server as the requester, and the number of available times, and sends a request for creation of the anonymous communication address to the anonymous communication address management section 33 (step S710). If two or more user IDs as candidates to be provided exist, request for creation of the anonymous communication address with the two or more user IDs specified may be sent, or two or more creation requests for the anonymous communication address may be sent on a user ID basis.

The anonymous communication address management section 33 that received the request for creation of the anonymous communication address creates an anonymous communication address in association with each of combinations of the specified user IDs and the address of the communication service providing server (step S711). Further, when the number of available times is specified, the specified number of available times is also associated. Then, the created anonymous communication address is sent back to the anonymous communication address providing section 32 (step S712).

The anonymous communication address providing section 32 that received the reply sends a response on the anonymous communication address including the created anonymous communication address back to the communication service providing server (step S713). When the created anonymous communication address is provided to the communication service providing server, the number of available times may also be notified. Like in the third exemplary embodiment, service categories for which the anonymous communication address is available may be specified in the exemplary embodiment.

The number of times the created anonymous communication address is available is controlled by the anonymous communication address management section 33 that received the request for the user ID from the mail server 20 when the communication service providing server as the providing destination uses the anonymous communication address.

In other words, the communication address conversion section 22 of the mail server 20 that received an e-mail obtains an anonymous communication address from an e-mail destination address, and sends the anonymous communication address management section 33 of the HTTP proxy server 30 a request for the user ID with the obtained anonymous communication address specified. The anonymous communication address management section 33 searches for information registered with itself and in which the anonymous communication address is associated with the user ID and the address of the communication service providing server address, settles a user ID corresponding to the specified anonymous communication address, and sends a user ID response including the obtained user ID back to the communication address conversion section 22 as the requester. If a user ID corresponding to the specified anonymous communication address exists, the anonymous communication address management section 33 can decrement, by one, the number of available times (334) set for the anonymous communication address in the association information registered with itself. Here, if the number of available times becomes zero, the use of the anonymous communication address is halted. The information on the anonymous communication address may be deleted from the association information. The other operations regarding the conversion from the anonymous communication address to an actual communication address may be the same as those in the first exemplary embodiment.

As described above, according to the exemplary embodiment, providing the anonymous communication address is controlled based on the history of access to the website so that an anonymous communication address providing destination can be decided by going back to the accesses in the past. Further, since the anonymous communication address can be provided in response to a request for the anonymous communication address from the side of the communication service providing server 42, the use of the anonymous communication address can be made available at any timing on the side of using the anonymous communication address.

In the exemplary embodiment, the number of available times of the anonymous communication address is decided from the total access time to the website, but the decision on the number of available times based on the history of access to the website is not limited thereto. For example, it may be decided based on the number of accesses to the website. In such a case, a data item of the number of use times based on the access frequency can be added to the anonymous communication address providing condition management section 34 to decide on the number of available times of the anonymous communication address depending on the number of accesses within a predetermined period of time.

The total access time that can be calculated from the history of access to the website or the access frequency is not limited to the calculation of the number of available times of the anonymous communication address. For example, the expiration date (available period) of the anonymous communication address may be set depending on the total access time or the access frequency. For example, when the communication service providing server provides information through audio streaming, it is possible to use it to update advertisements to a user terminal that has accessed a website through the audio streaming for only a period of access time to the website associated with the communication service providing server.

### Fifth Exemplary Embodiment

Next, a fifth exemplary embodiment of the present invention will be described. In the exemplary embodiment, means for communicating with a user terminal using an anonymous communication address is also provided to a provider operating a Web server for providing information to a mashup server.

In the exemplary embodiment, the mashup server is a server for collecting and processing (mashup) information on two or more Web servers to provide information services to user terminals. The Web service server is a Web server for providing information to the mashup server. The Web service server is different from the Web server in the first to fourth exemplary embodiments in that the information provided does not need to be visually readable by the user on the browser of the user terminal like the website written in HTML.

For example, in the case of a Web service server for providing weather information, the weather conditions may be provided by numeric values, like 1 as sunny, 2 as cloudy, 3 as rain and 4 as thunderstorm. Although this is information impossible for the browser of the user terminal to understand, it is enough as long as the information is understandable to the mashup server.

FIG. 22 is a block diagram showing a configuration example of an anonymous communication address providing system according to the fifth exemplary embodiment. The anonymous communication address providing system shown in FIG. 22 includes the user terminal 10, the mail server 20, the HTTP proxy, server 30, the communication service providing server 42, a mashup server 51, a Web service server 52, and an HTTP proxy server 70 for Web server. The user terminal 10, the mail server 20, the HTTP proxy server 30, the communication service providing server 42, the mashup server 51, the Web service server 52, and the HTTP proxy server 70 for Web server are connected through a network 60.

Note that the user terminal 10, the mail server 20, and the communication service providing server 42 are the same as those in the first to fourth exemplary embodiments.

The HTTP proxy server 30 may be the same as any of those in the first to fourth exemplary embodiments, except that the HTTP protocol information receiving section 31 is replaced with an HTTP protocol information receiving/converting section 37. In the example shown in FIG. 22, a case is taken as an example in which the HTTP protocol information receiving section 31 of the HTTP proxy server 30 in the fourth exemplary embodiment is replaced with the HTTP protocol information receiving/converting section 37.

In addition to the function of the HTTP protocol information receiving section 31 in the first to fourth exemplary embodiments, the HTTP protocol information receiving/converting section 37 converts a user ID of communication data in a received HTTP protocol into a temporary user ID (hereinafter referred to as temporary user ID) to send the communication data.

The mashup server 51 receives a request for a website from the user terminal 10 via the HTTP proxy server 30, obtains information necessary to create the website from the Web service server 52 to be described later, creates the website, and sends information on the website back to the user terminal 10 as the requester.

In the exemplary embodiment, the mashup server 51 will be described by taking a case of creating a website for a shopping mall as an example.

The Web service server 52 is a Web server for providing information to the mashup server 51. In the exemplary embodiment, it provides information on restaurants in the shopping mall to the mashup server 5I.

The HTTP proxy server 70 for Web server is a proxy server placed between the mashup server 51 and the Web service server 52, including a Web server HTTP protocol information receiving/converting section 71 and a temporary user ID management section 72.

In addition to the function of the HTTP protocol information receiving section 31 of the HTTP proxy server 30 in the first to fourth exemplary embodiments, the Web server HTTP protocol information receiving/converting section 71 converts the temporary user ID of HTTP protocol communication data received from the mashup server 51 into a new temporary user ID.

The temporary user ID management section 72 has a temporary user ID to convert a user ID indicative of the same user on a HTTP protocol basis to prevent the consolidation of personal information on users between service providers in a negative way from the HTTP protocol communication data sent and received via the HTTP proxy server 30 and the HTTP proxy server 70 for Web server.

Here, the consolidation of personal information on users in a negative way means a problem that fragmented personal information possessed by different service providers is consolidated and this leads to identifying individuals.

FIG. 23 is an explanatory drawing showing an example of data registered with the temporary user ID management section 72. Shown in FIG. 23 is an example of having, as the structure of data registered with the temporary user ID management section 72, items of received user ID (721), Web server ID (722), and temporary user ID (723).

Stored in the received user ID (721) are user IDs (which may be temporary user IDs) of communication data in HTTP protocol received by the HTTP protocol information receiving/converting section 37 or the Web server HTTP protocol information receiving/converting section 71.

Stored in the Web server ID (722) are Web server IDs of Web servers as access destinations to which temporary user IDs are assigned. Stored in the temporary user ID (723) are the assigned temporary user IDs.

For example, in the example shown in FIG. 23, it is shown that the user ID “user0001” is converted to temporary user ID “temp0001” when the user or the user terminal 10 with the user ID “user0001” accesses the Web server with the Web server ID “www.shoppingmall.co.jp.” Further, for example, it is shown that the user ID “temp0001” is converted to temporary user ID “temp0002” when the user or the user terminal 10 with the user ID (here, temporary user ID) “temp0001” accesses the Web server with the Web server ID “www.restaurant.co.jp.”

FIG. 24 is an explanatory drawing showing an example of data registered with the access history management section 36 in the exemplary embodiment. As shown in FIG. 24, data registered with the access history management section 36 in the exemplary embodiment may be the same as that in the fourth exemplary embodiment. However, if the user ID indicated by the communication data in HTTP protocol is a temporary user ID, the access history management section 36 will check with the temporary user ID management section 72 to register the user 1D after converting the temporary user ID to an actual user ID (real user ID).

Thus, when the Web server ID and the user ID are associated at timing as a trigger to provide an anonymous communication address, since the Web server ID of the Web service server and a real user ID can be associated, the anonymous communication address can also be provided to a service provider associated with the Web service server to enable communication with the user or the user terminal indicated by the real user ID. The other points are the same as those in the fourth exemplary embodiment.

Next, the operation of the exemplary embodiment will be described. FIG. 25 is a sequence diagram showing an example of operation of the anonymous communication address providing system of the exemplary embodiment.

In the exemplary embodiment, as shown in FIG. 25, when an HTTP request for receiving information on a website is sent from the browser 11 of the user terminal 10 toward a Web server (here, the mashup server 51) (step S801), the HTTP protocol information receiving/converting section 37 of the HTTP proxy server 30 that received the request obtains a user ID (here, a real user ID) and a Web server ID from the received HTTP request, detects access to a website (step S802), and outputs a website access notification to the access history management section 36 (step S803). In this example, it is assumed that the user ID “user001” and a Web server ID “www.shoppingmall.co.jp” are obtained from the HTTP request. The operations of steps S801 to S803 may be the same as those of steps S501 to S503 in the fourth exemplary embodiment.

The access history management section 36 that received the website access notification uses the notified user ID and. Web server ID and sets the current date and time as the website access time (361) to create and store history information in the storage area (step S804). At this point, the website access time (362) is empty (see the second record in FIG. 24).

Next, the HTTP protocol information receiving/converting section 37 specifies the obtained user ID and Web server ID and sends a request for creation of a temporary user ID to the temporary user ID management section 72 of the HTTP proxy server 70 for Web server (step S805).

The temporary user ID management section 72 that received the request for creation of a temporary user ID assigns a temporary user ID for the specified user ID, and stores the created temporary user ID in association with the specified user ID and Web server ID (step S806). The temporary user ID to be associated may be created using random numbers or selected from unused temporary user IDs prepared in advance. Then, a temporary user ID creation response including the created temporary user ID is sent back to the HTTP protocol information receiving/converting section 37 of the HTTP proxy server 30 as the requester (step S807). Here, as shown on the second record in FIG. 23, it is assumed that temporary user ID “temp0001” is assigned for the received user ID “user0001” associated with the Web server ID “www.shoppingmall.co.jp.”

The HTTP protocol information receiving/converting section 37 that received the temporary user ID creation response converts the user ID in the HTTP request received from the user terminal 10 into the received temporary user ID, and sends it to the mashup server 51 as the access destination (step S808).

The mashup server 51 that received the HTTP request sends an HTTP request including the user ID (here, the temporary user ID “temp0001”) in the received HTTP request toward the Web service server 52 as a destination from which information is further to be collected in order to collect and process information from other Web servers (step S809). In the exemplary embodiment, it is assumed that the mashup server 51 for a shopping mall sends an HTTP request to a Web server with the Web service ID “www.restaurant.co.jp” as the Web service server 52 of a restaurant owner to obtain information on the restaurant.

Further, in the exemplary embodiment, the communication data in HTTP protocol sent from the mashup server 51 is redirected to the Web service server 52 as the destination via the HTTP proxy server 70 for Web server.

In the HTTP proxy server 70 for Web server that received the HTTP request sent from the mashup server 51, the Web server HTTP protocol information receiving/converting section 71 obtains the user ID (here, the temporary user ID “temp0001”) and the Web server ID (“www.restaurant.co.jp”) from the received HTTP protocol. When the obtained user ID is a temporary user ID, the Web server HTTP protocol information receiving/converting section 71 specifies the obtained temporary user ID and sends a request for a real user ID to the temporary user ID management section 72 (step S810).

The temporary user ID management section 72 that received the request for a real user ID determines, from the specified temporary user ID, a real user Ill for which the temporary user ID is assigned, and sends it back (step S811: transmission of real user ID response). The temporary user ID management section 72 can repeat processing for determining a received user ID (721) in the record on which the specified temporary user ID is registered as the user ID (723) until the received user ID (721) becomes the real user ID.

The Web server HTTP protocol information receiving/converting section 71 that received the real user ID response specifies the settled real user ID (here, the user ID “user0001”) and the received Web server ID (“www.restaurant.co.jp”) and sends a website access notification to the access history management section 36 (step S812).

Like in step S804, the access history management section 36 that received the website access notification uses the notified user ID and Web server ID and sets the current date and time as the website access time (361) to create and store history information in the storage area (step S813, see the third record in FIG. 24).

Next, the Web server HTTP protocol information receiving/converting section 71 requests the temporary user ID management section 72 to further create a temporary user ID for the temporary user ID received for user ID to be given to the Web service server as the access destination. Like the HTTP protocol information receiving/converting section 37 in step S805, the Web server HTTP protocol information receiving/converting section 71 specifies the obtained user ID (here, the temporary user ID “temp0001”) and Web server ID (here, “www.restaurant.co.jp”) and sends a request for creation of temporary user ID to the temporary user ID management section 72 (step S814).

The temporary user ID management section 72 that received the request for creation of temporary user ID assigns a temporary user ID for the specified user ID and stores the created temporary user ID in association with the specified user ID and Web server ID (step S815). Then, a temporary user ID creation response including the created temporary user ID is sent back to the Web server HTTP protocol information receiving/converting section 71 as the requester (step S816). Here, as shown on the third record in FIG. 23, it is assumed that temporary user ID “temp0002” is assigned for the received user ID “temp0001” associated with the Web server ID “www.restaurant.co.jp.”

The Web server HTTP protocol information receiving/converting section 71 that received the temporary user ID creation response including the new temporary user ID converts the user ID (here, the temporary user ID “temp0001”) in the HTTP request received from the mashup server 51 into the received temporary user ID (“temp0002”) and sends it to the Web service server 52 as the access destination (step S817).

In the example of the exemplary embodiment, though the Web service server does not call up still another Web service server for ease of explanation, a new temporary user ID is further created from the received temporary user ID, allowing for a case where the Web service server further calls up still another Web service server.

The Web service server 52 that received the HTTP request sends communication data (which may not be necessarily formatted as a website as long as it is communication data sent via the HTTP protocol) including information on the restaurant such as vacant seat information and a recommended menu back to the mashup server 51 via the HTTP proxy server 70 for Web server as the requester (steps S818 and S819).

The mashup server 51 that received the data sent back from the Web service server 52 via the HTTP protocol processes a website from the received information (step S820), and sends information on the created website as an HTTP response back to the user terminal 10 as the original access source via the HTTP proxy server 30 (step S821). In this HTTP response, though the temporary user ID “temp0001” as the user ID in the HTTP request received from the HTTP proxy server 30 is specified as the user ID, a real user ID is settled by the HTTP proxy server 30 to redirect the HTTP response to the user terminal 10.

After the access status from the user terminal 10 to the website of the mashup server 51 is stored as an access history in the access history management section 36, an anonymous communication address can be provided in response to the transmission of a request for the anonymous communication address from the communication service providing server in the same manner as in the fourth exemplary embodiment.

Thus, according to the exemplary embodiment, an anonymous communication address can also be provided to a provider operating the Web service server for providing information to the mashup server to enable communication with the user or the user terminal using the anonymous communication address.

Note that the procedure for settling a temporary user ID in the exemplary embodiment can also be applied to the anonymous communication address providing method in the first exemplary embodiment as well as the anonymous communication address providing method in the fourth exemplary embodiment. For example, the HTTP proxy server 70 for Web server may include an anonymous communication address providing section for Web server having the same function as the anonymous communication address providing section 32 of the HTTP proxy server 30 so that an anonymous communication address can be provided to a service provider (in this example, the restaurant owner) associated with the Web service server 52 as means of communication with a user or a user terminal that has accessed the mashup server 51 depending on the access status from the mashup server 51 to the Web service server 52.

Next, the summary of the present invention will be described. FIG. 26 is a block diagram showing the summary of the present invention. As shown in FIG. 26, an information processing device 1 according to the present invention includes HTTP protocol information receiving means 101, communication address storage means 102, and communication address providing means 103.

The HTTP protocol information receiving means 101 (e.g., the HTTP protocol information receiving section 31) obtains information indicative of communication status of a user terminal via an HTTP protocol. For example, the HTTP protocol information receiving means 101 may also be configured to obtain data on communication of the user terminal using the HTTP protocol and specify the communication status indicated by the data in order to obtain information indicative of that effect.

The communication address storage means 102 (e.g., the anonymous communication address management section 33) stores a communication address provided by the communication address providing means 101 in association with information capable of identifying the user or the user terminal specified by the communication address. For example, the communication address storage means 102 may also be configured to have the communication address in association with a user identifier for identifying the user terminal or the user to which the communication address is to be assigned and a Web server identifier for identifying a Web server as an access destination that triggers providing the communication address.

The communication address providing means 103 (e.g., the anonymous communication address providing section 32) provides a communication address capable of specifying the user or the user terminal as the destination of a communication service to a communication service providing server as a server for providing the communication service. In the present invention, the communication address providing means 103 provides the communication address capable of specifying the user terminal or the user using the user terminal to the communication service providing server associated with a Web server as a communication partner via the HTTP protocol based on the communication status of the user terminal via the HTTP protocol. Note that “capable of specifying the user or the user terminal” specifically means that it can be specified as a destination upon transmission of information to the user or the user terminal.

The communication address providing means 103 may also be configured to provide the communication address when the user terminal starts accessing the Web server via the HTTP protocol. Further, it may be configured to provide the communication address when the user terminal finishes accessing the Web server via the HTTP protocol.

FIG. 27 is a block diagram showing another configuration example of the information processing device 1 according to the present invention. As shown in FIG. 27, the information processing device 1 may further include communication status history storage means 104. The communication status history storage means 104 (e.g., the access history management section 36) stores a history of communication status of the user terminal using the HTTP protocol. In such a case, the communication address providing means 103 may be configured to provide the communication address based on the history of the communication status stored in the communication status history storage means 104 when receiving information indicative of a request for a communication address from the communication service providing server.

The information processing device 1 may further include communication address providing condition storage means 105. For example, the communication address providing condition storage means 105 (e.g., the anonymous communication address providing conditions management section 34) stores communication address providing conditions including at least information on the communication service providing server corresponding to the Web server as the access destination. In such a case, the communication address providing means 103 may decide on an HTTP request that triggers providing the communication address based on the information stored in the communication address providing condition storage means among information in the HTTP request sent from the user terminal.

According to such a configuration, the service provider to which the communication address is to be provided can be distinguished from service providers from service providers to which the communication address is not to be provided.

Further, for example, the communication address providing condition storage means 105 may store, as the communication address providing conditions, information including information on the number of available times or the expiration date of the communication address to be provided. In such a case, based on the communication address providing conditions stored in the communication address providing condition storage means, the communication address providing means 103 may decide on the number of available times or the expiration date of the communication address to be provided.

Further, the communication address providing means 103 may perform control to invalidate the communication address based on any one of the communication status of the user terminal using the HTTP protocol, the number of times the communication address has been used, and the length of time that has elapsed since the communication address was provided.

Further, for example, the information processing device 1 may include user taste information storage means 106 (e.g., the user taste information management section 35). For example, the user taste information storage means 106 stores information indicative of the tastes of the user or a user using the user terminal to which the communication address is to be assigned. In such a case, the communication address providing condition storage means 105 may store the communication address providing conditions including at least information indicative of service categories of the Web server as the access destination that trigger providing the communication address. Further, based on the user taste information stored in the user taste information storage means 106 and the Web server service category information stored in the communication address providing condition storage means 105, the communication address providing means 103 may decide on the communication service providing server to which the communication address is to be provided, or the user or the user terminal to which the communication address is to be assigned.

According to such a configuration, category information in which the user shows interest in communication services provided by the communication service providing server using the communication address can be provided.

Further, the information processing device I may include temporary user ID creation means 107 (e.g., the HTTP protocol information receiving/converting section 37 and the temporary user ID management section 72) and temporary user ID storage means 108 (e.g., the temporary user ID management section 72). The temporary user ID creation means 107 creates a temporary user ID as a temporary user identifier used by the Web server in association with a user identifier as information capable of identifying the user or the user terminal. The temporary user ID storage means 108 stores the user identifier and the created temporary user ID in association with each other. In such a case, the communication status history storage means 104 may store a history of converting the temporary user ID using in communication into the user identifier.

According to such a configuration, the communication address can also be provided to a provider operating a Web service server for providing information to a mashup server to enable communication with the user or the user terminal.

Further, the communication address provided by the communication address providing means 103 may be an anonymous communication address.

FIG. 28 is a block diagram showing the summary of a communication address providing system according to the present invention. As shown in FIG. 28, the communication address providing system according to the present invention is a communication address providing system for providing a communication address capable of specifying a user or a user terminal as the destination of a communication service to a communication service providing server as a server for providing the communication service, the system characterized by comprising: HTTP protocol information receiving means 101, communication address storage means 102, and communication address providing means 103. For example, as shown in FIG. 28, the HTTP protocol information receiving means 101, the communication address storage means 102, and the communication address providing means 103 may be implemented in a first communication device 1 capable of receiving information indicative of communication status of the user terminal or a user terminal used by the user, to which the communication address is to be assigned, using an HTTP protocol. For example, the first communication device is an HTTP proxy server.

Further, as shown in FIG. 28, the communication address providing system according to the present invention may further comprises communication address conversion means 201 (e.g., the communication address conversion section 22) for checking with the communication address storage means 102 upon delivery control of communication data using the communication address to be provided by the communication address providing means 103 to specify the user or the user terminal as the destination. For example, the communication address conversion means 201 may be implemented in a second communication device 2 for performing control of the delivery of communication data using, as a destination, the communication address to be provided. For example, the second communication device 2 is a mail server.

FIG. 29 is a block diagram showing another configuration example of the communication address providing system according to the present invention. As shown in FIG. 29, the temporary user ID creation means 107 and the temporary user ID storage means 108 may be implemented as a communication address providing system in a third communication device 3 different from the first communication device 1 and placed between a user terminal 3 and a Web server 4 as an access destination. For example, when the Web server 4 as the access destination is a mashup server, the third communication device 3 is an HTTP proxy server placed between the mashup server and a Web service server for providing information to the mashup server.

Though not shown, the communication address storage means 102, the communication address providing means 103, the communication status history storage means 104, the communication address providing condition storage means 105, and the user taste information storage means 106 may be implemented by devices different from the first communication device 1 and comprising the HTTP protocol information receiving means 101, respectively. In such a case, it is assumed that the first communication device 1 and the devices are connected to be able to communicate with each other.

While the exemplary embodiments and the present invention with reference to the examples have been described, the present invention is not intended to be limited to the aforementioned exemplary embodiments and examples. Various changes understandable to those skilled in the art can be made in the configurations and details of the present invention within the scope of the present invention.

This application claims priority based upon Japanese Patent Application No. 2008-301143 filed Nov. 26, 2008, which is incorporated by reference herein in its entirety.

### INDUSTRIAL APPLICABILITY

The present invention is suitably applicable to applications for actively providing communication services, such as advertising mails or advertising calls, to a user terminal that shows interest in the communication services without providing personal information, such as a mail address or a telephone number, to a service provider.

### REFERENCE SIGNS LIST

1 Information Processing Device (First Communication Device)

2 Second Communication Device

3 User Terminal

4 Web Server

5 Communication Service Providing Server

6 Network

7 Third Communication Device

10 User Terminal

11 Browser (including an operating environment for an application)

12 Mail Client (including an operating environment for an application)

20 Mail Server

21 Communication Address Management Section

22 Communication Address Translation Section

30 HTTP Proxy Server

31 HTTP Protocol Information Receiving Section

32 Anonymous Communication Address Providing Section

33 Anonymous Communication Address Management Section

34 Anonymous Communication Address Providing Condition Management Section

35 User Preference Information Management Section

36 Access History Management Section

37 HTTP Protocol Information Receiving/Translating Section

41 Web Server

42 Communication Service Providing Server

51 Mashup Type Web Server

52 Web Service Server

60 Network

70 HTTP Proxy Server for Web Server

71 HTTP Protocol Information Receiving/Translating Section for Web Server

72 Temporary User ID Management Section

101 HTTP Protocol Information Receiving Means

102 Communication Address Storage Means

103 Communication Address Providing Means

104 Communication Status History Storage Means

105 Communication Address Providing Condition Storage Means

106 User Preference Information Storage Means

107 Temporary User ID Generation Means

108 Temporary User ID Storage Means

201 Communication Address Translation Means

1-24. (canceled)

25. An information processing device comprising:
a communication address providing section for providing a communication address, capable of specifying a user or a user terminal as a destination of a communication service, to a communication service providing server as a server for providing the communication service;
an HTTP protocol information receiving section for receiving information indicative of communication status of the user terminal via an HTTP protocol; and
a communication address storage section for storing the communication address, provided by the communication address providing section, in association with information capable of identifying the user or the user terminal specified by the communication address,
wherein, based on the communication status of the user terminal via the HTTP protocol, the communication address providing section provides a communication address capable of specifying the user terminal or the user using the user terminal to the communication service providing server associated with a Web server as a communication partner via the HTTP protocol.

26. The information processing device according to claim 25, wherein the communication address providing section provides the communication address when the user terminal start accessing the Web server via the HTTP protocol.

27. The information processing device according to claim 25, wherein the communication address providing section provides the communication address when the user terminal finishes accessing the Web server via the HTTP protocol.

28. The information processing device according to claim 25, further comprising
a communication status history storage section for storing a history of communication status of the user terminal via the HTTP protocol,
wherein when receiving information indicative of a request for a communication address from the communication service providing server, the communication address providing section provides the communication address based on the history of communication status stored in the communication status history storage section.

29. The information processing device according to claim 28, wherein
the information capable of identifying the user or the user terminal is a user identifier corresponding to the user or the user terminal,
the device further comprises
a temporary user ID creation section for creating a temporary user ID as a temporary user identifier, to be used by the Web server, in association with the user identifier, and
a temporary user ID storage section for storing the user identifier and the created temporary user ID in association with each other, and
the communication status history storage section stores a history of converting the temporary user ID used in communication into the user identifier.

30. The information processing device according to claim 25, further comprising
a communication address providing condition storage section for storing communication address providing conditions including at least information on a communication service providing server corresponding to a Web server as an access destination,
wherein, based on the information stored in the communication address providing condition storage section, the communication address providing section decides on an HTTP request as a trigger to provide a communication address from among HTTP requests sent from the user terminal.

31. The information processing device according to claim 25, further comprising:
a user taste information storage section for storing information indicative of tastes of the user or a user using the user terminal to which a communication address is to be assigned; and
a communication address providing condition storage section for storing communication address providing conditions including at least information indicative of a service category of the Web server as the access destination as a trigger to provide a communication address,
wherein, based on the user taste information stored in the user taste information storage section and the service category information on the Web server stored in the communication address providing condition storage section, the communication address providing section decides on the communication service providing server as a communication address providing destination, or the user or the user terminal to which the communication address is to be assigned.

32. The information processing device according to claim 25, wherein
the communication address providing condition storage section stores, as communication address providing conditions, information including information on the number of available times or the expiration date of the provided communication address, and
based on the communication address providing conditions stored in the communication address providing condition storage section, the communication address providing section decides on the number of available times or the expiration date of the provided communication address.

33. The information processing device according to claim 25, wherein the communication address providing section performs control to invalidate the communication address based on any one of the communication status of the user terminal via the HTTP protocol, the number of times the communication address has been used, and the length of time that has elapsed since the communication address was provided.

34. The information processing device according to claim 25, wherein the communication address provided by the communication address providing section is an anonymous communication address.

35. A communication address providing system comprising:
a communication address providing section for providing a communication address, capable of specifying a user or a user terminal as a destination of a communication service, to a communication service providing server as a server for providing the communication service;
an HTTP protocol information receiving section for receiving information indicative of communication status of the user terminal via an HTTP protocol; and
a communication address storage section for storing the communication address, provided by the communication address providing section, in association with information capable of identifying the user or the user terminal specified by the communication address,
wherein, based on the communication status of the user terminal via the HTTP protocol, the communication address providing section provides the communication address, capable of specifying the user terminal or the user using the user terminal, to the communication service providing server associated with a Web server as a communication partner via the HTTP protocol.

36. The communication address providing system according to claim 35, further comprising communication address conversion section for checking with the communication address storage section when the communication address providing section performs control of delivery of communication data using, as a destination, the communication address provided by the communication address providing section to specify the user or the user terminal as the destination.

37. The communication address providing system according to claim 35, further comprising
a communication status history storage section for storing a history of communication status of the user terminal via the HTTP protocol,
wherein when receiving information indicative of a request for a communication address from the communication service providing server, the communication address providing section provides the communication address based on the history of communication status stored in the communication status history storage section.

38. The communication address providing system according to claim 35, wherein
the information capable of identifying the user or the user terminal is a user identifier corresponding to the user or the user terminal,
the system further comprises
a temporary user ID creation section for creating a temporary user ID as a temporary user identifier, to be used by the Web server, in association with the user identifier, and
a temporary user ID storage section for storing the user identifier and the created temporary user ID in association with each other, and
the communication status history storage section stores a history of converting the temporary user ID used in communication into the user identifier.

39. The communication address providing system according to claim 35, further comprising
a communication address providing condition storage section for storing communication address providing conditions including at least information on a communication service providing server corresponding to the Web server as an access destination,
wherein, based on information stored in the communication address providing condition storage section, the communication address providing section decides on an HTTP request as a trigger to provide a communication address from among HTTP requests sent from the user terminal.

40. The communication address providing system according to claim 35, further comprising:
a user taste information storage section for storing information indicative of tastes of the user or a user using the user terminal to which the communication address is to be assigned; and
a communication address providing condition storage section for storing communication address providing conditions including at least information indicative of a service category of the Web server as the access destination as a trigger to provide the communication address,
wherein, based on the user taste information stored in the user taste information storage section and the service category information on the Web server stored in the communication address providing condition storage section, the communication address providing section decides on the communication service providing server as a communication address providing destination, or the user or the user terminal to which the communication address is to be assigned.

41. A communication address providing method for providing a communication address, capable of specifying a user or a user terminal as a destination of a communication service, to a communication service providing server as a server for providing the communication service, the method comprising:
obtaining information indicative of communication status of the user terminal or a user terminal used by the user via an HTTP protocol, wherein the communication address is to be assigned to the user terminal;
providing, based on the obtained communication status of the user terminal via the HTTP protocol, a communication address, capable of specifying the user terminal or the user using the user terminal, to the communication service providing server associated with a Web server as a communication partner via the HTTP protocol; and
storing, in a storage device, the provided communication address in association with information capable of identifying the user or the user terminal specified by the communication address.

42. The communication address providing method according to claim 41, further comprising: providing a communication address based on a history of communication status of the user terminal via the HTTP protocol stored in the storage device in response to receiving information indicative of a request for the communication address from the communication service providing server.

43. The communication address providing method according to claim 41, further comprising: deciding on the number of available times or the expiration date of the provided communication address based on prestored communication address providing conditions.

44. The communication address providing method according to claim 41, further comprising: performing control to invalidate the communication address based on any one of the communication status of the user terminal via the HTTP protocol, the number of times the communication address has been used, and the length of time that has elapsed since the communication address was provided.

45. A communication address providing program for providing a communication address, capable of specifying a user or a user terminal as a destination of a communication service, to a communication service providing server as a server for providing the communication service, the program making a computer perform
processing for receiving information indicative of communication status of the user terminal or a user terminal used by the user via an HTTP protocol, wherein the communication address is to be assigned to the user terminal, and
processing for providing, based on the obtained communication status of the user terminal via the HTTP protocol, a communication address capable of specifying the user terminal or the user using the user terminal to the communication service providing server associated with a Web server as a communication partner via the HTTP protocol.

46. The communication address providing program according to claim 45, making the computer further perform processing for providing a communication address based on a history of communication status of the user terminal via the HTTP protocol stored in the storage device in response to receiving information indicative of a request for the communication address from the communication service providing server.

47. The communication address providing program according to claim 45, making the computer further perform processing for deciding on the number of available times or the expiration date of the provided communication address based on prestored communication address providing conditions.

48. The communication address providing program according to any claim 45, making the computer further perform processing for performing control to invalidate the communication address based on any one of the communication status of the user terminal via the HTTP protocol, the number of times the communication address has been used, and the length of time that has elapsed since the communication address was provided.
